(19) United States
(12) Patent Application Publication
(10) Pub. No.: US 2024/0125618 A1
(43) Pub. Date: Apr. 18, 2024

(54) LOCATION ESTIMATION SYSTEM, MOBILE OBJECT, LOCATION ESTIMATION METHOD, AND RECORDING MEDIUM

(71) Applicant: SONY GROUP CORPORATION, TOKYO (JP)

(72) Inventors: SATOSHI SUZUKI, TOKYO (JP); HIROTAKA TANAKA, TOKYO (JP); TAKAHITO NAKANO, TOKYO (JP)

(21) Appl. No.: 18/264,848

(22) PCT Filed: Dec. 28, 2021
(86) PCT No.: PCT/JP2021/048826

§ 371 Date: Aug. 9, 2023

(30) Foreign Application Priority Data
Feb. 19, 2021 (JP) 2021-025003

(51) Int. Cl. G01C 21/00

(52) U.S. Cl. CPC G01C 21/3841; G05D 1/2462

(57) ABSTRACT

A location estimation system includes at least four directional sensors that each acquire data used to estimate a location of a mobile object; a sensor assignment section that assigns one of the at least four sensors as a first sensor, and assigns, as a second sensor, one of the at least four sensors that is adjacent to the first sensor and situated on one of sides of the first sensor; an environment map generator that generates an environment map on the basis of first sensor data that is data acquired by the first sensor and on the basis of second sensor data that is data acquired by the second sensor; a first location estimator that estimates the location in the environment map on the basis of the first sensor data to generate a first sensor estimated location; a second location estimator that estimates the location in the environment map on the basis of the second sensor data to generate a second sensor estimated location; and a location integration section that integrates the first sensor estimated location and the second sensor estimated location to estimate the location of the mobile object in the environment map.

### TECHNICAL FIELD

The present disclosure relates to a location estimation system and a mobile object, the location estimation system generating an environment map of an environment in which the mobile object is situated, and estimating a location and a pose of the mobile object in the environment map. The present disclosure further relates to a method for estimating the location and the pose of the mobile object, and a non-transitory computer-readable recording medium that records therein a location estimation program.

### BACKGROUND ART

Simultaneous localization and mapping (SLAM) is known that is used to estimate a location and a pose of a mobile object and to generate an environment map.

### CITATION LIST

### Patent Literature

Patent Literature 1: Japanese Patent Application Laid-open No. 2017-146893
Patent Literature 2: Japanese Patent Application Laid-open No. 2014-211862
Patent Literature 3: Japanese Patent Application Laid-open No. 2016-537645
Patent Literature 4: Japanese Patent Application Laid-open No. 2016-197083

### DISCLOSURE OF INVENTION

### Technical Problem

When SLAM is applied using a plurality of sensors and when sensor information obtained by all of the plurality of sensors is processed, this may result in a very high calculation load. This is not a realistic way of applying SLAM using a plurality of sensors from the viewpoint of responsiveness and power consumption of a system. A method including switching between sensors of a plurality of sensors to apply SLAM is conceivable, in order to avoid the issue described above. However, the application of this method may cause an error in measurement performed by a single sensor and variations in error between sensors of a plurality of sensors. This may result in a change in location. As described above, there is a trade-off relationship between calculation costs and the accuracy in location estimation.

Patent Literature 1 discloses suppressing a reduction in the accuracy in location by calculating the suitability of a sensor using an environment map and a group of points obtained from the sensor. In this method, information regarding a sensor of which the suitability does not meet criteria is not used for location estimation. Thus, this method may lead to wasted calculation costs (an increase in calculation load). Patent Literature 2 discloses calculating a location using two different sensors and two different estimation approaches. This method may lead a decrease in reliability when one of the two sensors is inoperative due to malfunction. Patent Literature 3 discloses that the reliability may be decreased when a landmark is lost.

In view of the circumstances described above, it is desirable that a location and a pose be estimated with a high degree of accuracy at low calculation costs.

### Solution to Problem

A location estimation system according to an embodiment of the present disclosure includes:
at least four directional sensors that each acquire data used to estimate a location and a pose of a mobile object;
a sensor assignment section that
   assigns one of the at least four sensors as a first sensor,
   assigns, as a second sensor, one of the at least four sensors that is adjacent to the first sensor and situated on one of sides of the first sensor,
   assigns, as a spare sensor, one of the at least four sensors that is adjacent to the first sensor and situated on another of the sides of the first sensor, and
   swaps the assignments of the second sensor and the spare sensor when the second sensor does not satisfy a first condition and the spare sensor satisfies a second condition;
an environment map generator that generates an environment map on the basis of first sensor data that is data acquired by the first sensor and on the basis of second sensor data that is data acquired by the second sensor;
a first location estimator that estimates the location and the pose in the environment map on the basis of the first sensor data to generate a first sensor estimated location;
a second location estimator that estimates the location and the pose in the environment map on the basis of the second sensor data to generate a second sensor estimated location; and
a location integration section that integrates the first sensor estimated location and the second sensor estimated location to estimate the location and the pose of the mobile object in the environment map.

According to the present embodiment, the location estimation system only selects two of at least four sensors to estimate a location and a pose of the mobile object. This makes it possible to increase a degree of reliability of location estimation and to reduce a calculation load imposed upon performing the location estimation. This results in being able to reduce power consumption.

The sensor assignment section may swap the assignments of the first sensor and the second sensor when the number of feature points included in the first sensor data is less than or equal to the number of feature points included in the second sensor data and/or when a success rate of location estimation performed on the basis of the first sensor data is less than or equal to a success rate of location estimation performed on the basis of the second sensor data.

This makes it possible to estimate the location and the pose using two sensors used when relatively highly reliable location estimation is performed.

The second location estimator may newly generate a second sensor estimated location on the basis of second sensor data acquired by the newly assigned second sensor, and
the location integration section may integrate the first sensor estimated location and the newly generated second sensor estimated location to estimate the location and the pose of the mobile object.

When the location estimation system changes a pair of sensors, one of paired sensors (a first sensor) is not changed, whereas another of the paired sensors (a second sensor) is changed. In other words, only one of paired sensors is changed at a time. Further, one of paired sensors (a first sensor) that is more reliable is not changed, whereas another of the paired sensors (a second sensor) that is relatively less reliable is changed. Then, upon estimating a location, sensor data of the more reliable unchanged sensor (the first sensor) is used when the changed sensor (the second sensor) exhibits a large error. This makes it possible to perform smoothing on the location. Further, a simple change in sensor (for example, selecting two pairs of sensors at random) may result in the occurrence of discontinuity in a temporal change in location. However, in the present embodiment, a spare sensor adjacent to a first sensor and situated on another side of the first sensor is newly assigned as a second sensor when there is a change in second sensor. In other words, the first sensor being relatively highly reliable is not changed, whereas the second sensor is changed from a sensor adjacent to the first sensor and situated on one of sides of the first sensor to a sensor adjacent to the first sensor and situated on another of the sides of the first sensor. Such a change approach makes it possible to perform smoothing on a location to the fullest extent, and thus to suppress the occurrence of discontinuity. This results in obtaining a more reliable location.

When the number of feature points included in the second sensor data is less than or equal to the number of feature points included in spare sensor data that is data acquired by the spare sensor, and/or when the number of a plurality of voxels situated in a sensing range of the second sensor is less than or equal to a first threshold and the probability of occupation of each of the plurality of voxels situated in the sensing range of the second sensor is less than or equal to a second threshold, the sensor assignment section may determine that the second sensor does not satisfy the first condition, the plurality of voxels being included in the environment map, the probability of occupation of each of the plurality of voxels being represented in the environment map, or
when a success rate of location estimation performed on the basis of the second sensor data is less than or equal to a success rate of location estimation performed on the basis of the spare sensor data, and/or when the number of the plurality of voxels situated in the sensing range of the second sensor is less than or equal to the first threshold and the probability of occupation of each of the plurality of voxels situated in the sensing range of the second sensor is less than or equal to the second threshold, the sensor assignment section may determine that the second sensor does not satisfy the first condition.

Consequently, when location estimation performed using the second sensor is relatively less reliable, this second sensor is not used for location estimation. This makes it possible to prevent a reduction in a degree of reliability of location estimation.

When the number of feature points included in spare sensor data that is data acquired by the spare sensor is greater than or equal to a third threshold, and/or when the number of a plurality of voxels situated in a sensing range of the spare sensor is greater than a first threshold and the probability of occupation of each of the plurality of voxels situated in the sensing range of the spare sensor is greater than a second threshold, the sensor assignment section may determine that the spare sensor satisfies the second condition, the plurality of voxels being included in the environment map, the probability of occupation of each of the plurality of voxels being represented in the environment map, or
when a success rate of location estimation performed on the basis of the spare sensor data is greater than or equal to a fourth threshold, and/or when the number of the plurality of voxels situated in the sensing range of the spare sensor is greater than the first threshold and the probability of occupation of each of the plurality of voxels situated in the sensing range of the spare sensor is greater than the second threshold, the sensor assignment section may determine that the spare sensor satisfies the second condition.

Consequently, when location estimation performed using the second sensor is relatively less reliable, the spare sensor used when relatively highly reliable location estimation is performed, is newly assigned as the second sensor to estimate the location and the pose. This makes it possible to increase a degree of reliability of location estimation.

When the second sensor does not satisfy the first condition and the spare sensor does not satisfy the second condition, the sensor assignment section may determine that the second sensor and the spare sensor are not to be used for location estimation.

Consequently, when location estimations respectively performed using the second sensor and the spare sensor are relatively less reliable, these second sensor and spare sensor are not used for location estimation. This makes it possible to prevent a reduction in a degree of reliability of location estimation.

When the number of feature points included in spare sensor data that is data acquired by the spare sensor is less than a third threshold, and/or when the number of a plurality of voxels situated in a sensing range of the spare sensor is less than or equal to a first threshold and the probability of occupation of each of the plurality of voxels situated in the sensing range of the spare sensor is less than or equal to a second threshold, the sensor assignment section may determine that the spare sensor does not satisfy the second condition, the plurality of voxels being included in the environment map, the probability of occupation of each of the plurality of voxels being represented in the environment map, or
when a success rate of location estimation performed on the basis of the spare sensor data is less than a fourth threshold, and/or when the number of the plurality of voxels situated in the sensing range of the spare sensor is less than or equal to the first threshold and the probability of occupation of each of the plurality of voxels situated in the sensing range of the spare sensor is less than or equal to the second threshold, the sensor assignment section may determine that the spare sensor does not satisfy the second condition.

Consequently, when location estimation performed using the spare sensor is relatively less reliable, this spare sensor is not used for location estimation. This makes it possible to prevent a reduction in a degree of reliability of location estimation.

The location estimation system may further include:
a directional ranging-type sensor that acquires data used to estimate the location and the pose of the mobile object; and
a third location estimator that estimates the location and the pose in the environment map on the basis of sensor data acquired by the ranging-type sensor to generate a second sensor estimated location, and
in a case in which the sensor assignment section determines that the second sensor and the spare sensor are not to be used for location estimation,
the location integration section may integrate the first sensor estimated location and the second sensor estimated location to estimate the location and the pose of the mobile object when a degree of reliability of the ranging-type sensor is greater than or equal to a fifth threshold, and/or when the number of a plurality of voxels situated in a sensing range of the ranging-type sensor is greater than a first threshold and the probability of occupation of each of the plurality of voxels situated in the sensing range of the ranging-type sensor is greater than a second threshold, the plurality of voxels being included in the environment map, the probability of occupation of each of the plurality of voxels being represented in the environment map.

Consequently, the location and the pose are estimated using the ranging-type sensor used when relatively highly reliable location estimation is performed. This makes it possible to increase a degree of reliability of location estimation.

The location estimation system may further include:
an internal sensor that acquires internal data used to estimate the location and the pose of the mobile object; and
a fourth location estimator that estimates the location and the pose in the environment map on the basis of the internal data acquired by the internal sensor to generate a displacement measured by odometry, and
the location integration section may further integrate the displacement measured by odometry with the first sensor estimated location and the second sensor estimated location to estimate the location and the pose of the mobile object.

Consequently, the internal sensor can be further used for location estimation. This makes it possible to increase a degree of reliability of location estimation.

The at least four sensors may be image-capturing sensors or ranging sensors that each measure a distance on the basis of a signal received from an environment.

The present embodiment makes it possible to increase a degree of reliability of location estimation even when directional sensors are used.

The mobile object may be a flying object.

The present embodiment makes it possible to increase a degree of reliability of location estimation, and thus to prevent an accident or reckless driving caused due to a failure in location estimation (a loss of a location).

A mobile object according to an embodiment of the present disclosure includes:
at least four directional sensors that each acquire data used to estimate a location and a pose of the mobile object; and
a control circuit that operates as
   a sensor assignment section that
      assigns one of the at least four sensors as a first sensor,
      assigns, as a second sensor, one of the at least four sensors that is adjacent to the first sensor and situated on one of sides of the first sensor,
      assigns, as a spare sensor, one of the at least four sensors that is adjacent to the first sensor and situated on another of the sides of the first sensor, and
      swaps the assignments of the second sensor and the spare sensor when the second sensor does not satisfy a first condition and the spare sensor satisfies a second condition,
   an environment map generator that generates an environment map on the basis of first sensor data that is data acquired by the first sensor and on the basis of second sensor data that is data acquired by the second sensor,
   a first location estimator that estimates the location and the pose in the environment map on the basis of the first sensor data to generate a first sensor estimated location,
   a second location estimator that estimates the location and the pose in the environment map on the basis of the second sensor data to generate a second sensor estimated location, and
   a location integration section that integrates the first sensor estimated location and the second sensor estimated location to estimate the location and the pose of the mobile object in the environment map.

A location estimation method according to an embodiment of the present disclosure is a method for estimating a location and a pose of a mobile object that includes at least four directional sensors, the location estimation method including:
assigning one of the at least four sensors as a first sensor;
assigning, as a second sensor, one of the at least four sensors that is adjacent to the first sensor and situated on one of sides of the first sensor;
assigning, as a spare sensor, one of the at least four sensors that is adjacent to the first sensor and situated on another of the sides of the first sensor;
swapping the assignments of the second sensor and the spare sensor when the second sensor does not satisfy a first condition and the spare sensor satisfies a second condition;
generating an environment map on the basis of first sensor data that is data acquired by the first sensor and on the basis of second sensor data that is data acquired by the second sensor;
estimating the location and the pose in the environment map on the basis of the first sensor data to generate a first sensor estimated location;
estimating the location and the pose in the environment map on the basis of the second sensor data to generate a second sensor estimated location; and
integrating the first sensor estimated location and the second sensor estimated location to estimate the location and the pose of the mobile object in the environment map.

A non-transitory computer-readable recording medium according to an embodiment of the present disclosure records therein a location estimation program that causes a control circuit to operate as
a sensor assignment section that
   assigns, as a first sensor, one of at least four directional sensors that each acquire data used to estimate a location and a pose of a mobile object,
   assigns, as a second sensor, one of the at least four sensors that is adjacent to the first sensor and situated on one of sides of the first sensor,
   assigns, as a spare sensor, one of the at least four sensors that is adjacent to the first sensor and situated on another of the sides of the first sensor, and
   swaps the assignments of the second sensor and the spare sensor when the second sensor does not satisfy a first condition and the spare sensor satisfies a second condition,
an environment map generator that generates an environment map on the basis of first sensor data that is data acquired by the first sensor and on the basis of second sensor data that is data acquired by the second sensor,
a first location estimator that estimates the location and the pose in the environment map on the basis of the first sensor data to generate a first sensor estimated location,
a second location estimator that estimates the location and the pose in the environment map on the basis of the second sensor data to generate a second sensor estimated location, and
a location integration section that integrates the first sensor estimated location and the second sensor estimated location to estimate the location and the pose of the mobile object in the environment map,
the control circuit being capable of communicating with the at least four sensors.

### BRIEF DESCRIPTION OF DRAWINGS

FIG. 1 schematically illustrates an example of applying SLAM to a mobile object.

FIG. 2 schematically illustrates an overview of a mobile object according to a first embodiment of the present disclosure.

FIG. 3 illustrates a functional configuration of a location estimation system.

FIG. 4 illustrates a flow of an operation of the location estimation system.

FIG. 5 illustrates a functional configuration of a location estimation system according to a second embodiment of the present disclosure.

FIG. 6 illustrates a flow of an operation of the location estimation system.

FIG. 7 illustrates a flow of the operation of the location estimation system according to a third embodiment of the present disclosure.

FIG. 8 illustrates a flow of the operation of the location estimation system according to a fourth embodiment of the present disclosure.

### MODE(S) FOR CARRYING OUT THE INVENTION

Embodiments according to the present disclosure will now be described below with reference to the drawings.

### I. FIRST EMBODIMENT

1. Overview of SLAM

Simultaneous localization and mapping (SLAM) refers to performing location estimation and environment map generation at the same time. SLAM is a technology used to detect, using external sensors such as a camera and a laser distance sensor, a feature point, in a surrounding traveling environment, that serves as a landmark for a location, and to estimate the location and a pose on the basis of an absolute location of the feature that is obtained by referring to a map (map matching).

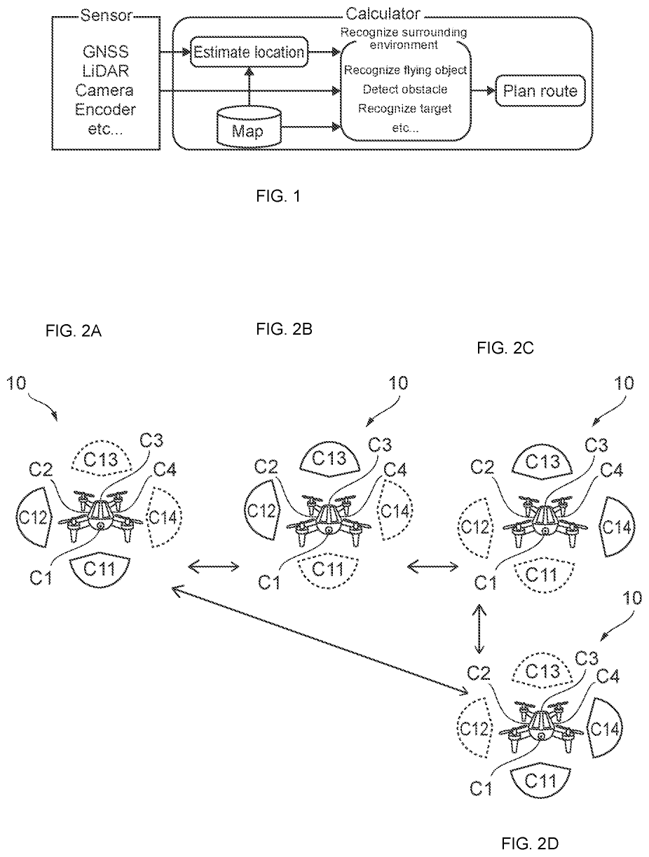

FIG. 1 schematically illustrates an example of applying SLAM to a mobile object.

Specifically, FIG. 1 illustrates a flow of automated driving when SLAM is applied to a mobile object. The mobile object is, for example, a flying object such as a drone. First, a location is estimated, and modules for, for example, obstacle detection and route planning are executed on the basis of a result of recognizing the location. The failure in location estimation (The loss of a location) may directly result in an accident or reckless driving.

When SLAM is applied using a plurality of sensors and when sensor information obtained by all of the plurality of sensors is processed, this may result in a very high calculation load. This is not a realistic way of applying SLAM using a plurality of sensors from the viewpoint of responsiveness and power consumption of a system. A method including switching between sensors of a plurality of sensors to apply SLAM is conceivable, in order to avoid the issue described above. However, the application of this method may cause an error in measurement performed by a single sensor and variations in error between sensors of a plurality of sensors. This may result in a change in location. As described above, there is a trade-off relationship between calculation costs and the accuracy in location estimation. In view of the circumstances described above, it is desirable that a location and a pose be estimated with a high degree of accuracy at low calculation costs.

2. Overview of Mobile Object

FIG. 2 schematically illustrates an overview of a mobile object according to a first embodiment of the present disclosure.

Examples of a mobile object 10 include a flying object such as a drone, a transfer robot at a factory, and a vehicle. In the present embodiment, the mobile object 10 is a flying object such as a drone. The mobile object 10 includes at least four (four in the present embodiment) sensors C1, C2, C3, and C4. The four sensors C1, C2, C3, and C4 each acquire external data used to estimate a location and a pose of the mobile object 10. The four sensors C1, C2, C3, and C4 are sensors of the same type and typically have the same specifications. In the present embodiment, each sensor is an image-capturing sensor, that is, a camera, and acquires image data. The sensors C1, C2, C3, and C4 may each be referred to as a camera.

Each of the sensors C1, C2, C3, and C4 is directional. In other words, a range (a sensing range) on which each of the sensors C1, C2, C3, and C4 can perform image-capturing is limited to a specific angle of view. Other examples of a directional sensor include a ranging sensor (a second embodiment) that measures a distance on the basis of a signal received from an environment. Conversely, examples of a nondirectional sensor include a Global Positioning System (GPS) sensor.

The four cameras C1, C2, C3, and C4 have different sensing ranges (angles of view), and are arranged such that their sensing ranges (ranges respectively corresponding to their angles of view) are maximally continuous with each other. In other words, the four cameras C1, C2, C3, and C4 are arranged such that a region of a blind spot is minimal. In the example illustrated in the figure, the mobile object 10 includes the four cameras C1, C2, C3, and C4, which are equally spaced in plane with each other at intervals of 90 degrees. Specifically, the camera C1 performing image-capturing on a fan-shaped sensing range C11 in front, the camera C2 performing image-capturing on a fan-shaped sensing range C12 on the right, the camera C3 performing image-capturing on a fan-shaped sensing range C13 in back, and the camera C4 performing image-capturing on a fan-shaped sensing range C14 on the left are adjacently arranged clockwise in this order at intervals of 90 degrees. Note that the numbers of cameras and arrangement of the cameras are not limited thereto. When the mobile object 10 is a flying object such as a drone, for example, a camera that performs image-capturing on a sensing range situated below may be further arranged on a bottom surface of the mobile object 10 or neat the bottom surface.

A location estimation system of the present embodiment does not estimate a location and a pose of the mobile object 10 on the basis of all of the pieces of image data respectively acquired by the four cameras C1, C2, C3, and C4. The location estimation system assigns two of the four cameras C1, C2, C3, and C4 for location estimation, and estimates a location and a pose of the mobile object 10 on the basis of pieces of image data respectively acquired by the two cameras. A method for assigning two cameras is briefly described.

The location estimation system selects any two adjacent cameras. For example, the location estimation system assigns two adjacent cameras that are the cameras C1 and C2 for location estimation, as illustrated in (A). When the location estimation system determines that location estimation performed on the basis of image data acquired by one of the assigned cameras that is the camera C1, is less reliable, the location estimation system only cancels the assignment of the camera C1 with less reliable location estimation, and assigns, for location estimation, the camera C3 adjacent to the assigned camera C2 and situated on another side of the assigned camera C2, as illustrated in (B). The location estimation system repeats such processes to estimate, at all times, a location and a pose on the basis of pieces of image data respectively acquired by two cameras used when relatively highly reliable location estimation is performed. Note that, in the figure, the cameras C3 and C4 are assigned in (C), and the cameras C4 and C1 are assigned in (D). However, this is a figure created in order to facilitate understanding of the description. The cameras are not intended to be assigned regularly in a circle, as described above (that is, in order of A, B, C, D, A, B . . . ).

3. Functional Configuration of Location Estimation System

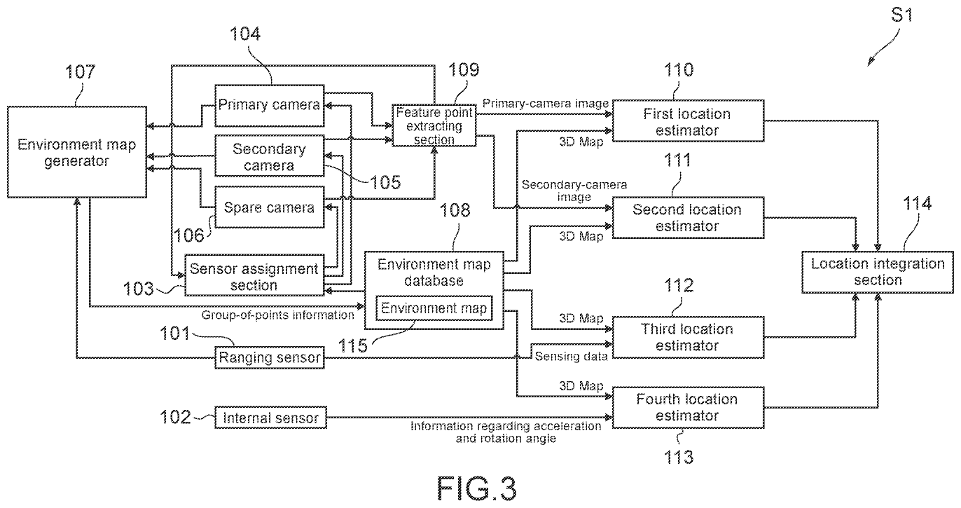

FIG. 3 illustrates a functional configuration of the location estimation system.

The mobile object 10 includes the four cameras C1, C2, C3, and C4 (FIG. 2), a ranging sensor 101, and an internal sensor 102 as built-in hardware sensors.

Each of the four cameras C1, C2, C3, and C4 acquires external data used to estimate a location and a pose of the mobile object 10. Each of the four cameras C1, C2, C3, and C4 is directional, and acquires image data used to estimate the location and the pose of the mobile object 10.

The ranging sensor 101 is directional, and acquires external data that is used to estimate a location and a pose of the mobile object 10 and of which a type is different from a type of data (image data) acquired by each of the four cameras C1, C2, C3, and C4. Specifically, the ranging sensor 101 measures a distance on the basis of a signal received from an environment to acquire distance data. More specifically, the ranging sensor 101 is a sensor (an active sensor) that adopts an approach in which a signal of, for example, an electromagnetic wave, light, or sound is output to an environment to receive a reflected wave. For example, the ranging sensor 101 includes a time-of-flight (ToF) sensor, LiDAR, a millimeter-wave radar, and/or an ultrasonic wave sonar.

The internal sensor 102 acquires internal data used to estimate a location and a pose of the mobile object 10. Specifically, the internal sensor 102 acquires data such as angular velocity, acceleration, and/or a rotation angle of a motor of the mobile object 10. The internal sensor 102 includes, for example, an inertial measurement unit (IMU) and/or a rotation-angle encoder.

A control circuit of a location estimation system S1 operates as a sensor assignment section 103, an environment map generator 107, a feature point extracting section 109, a first location estimator 110, a second location estimator 111, a third location estimator 112, a fourth location estimator 113, and a location integration section 114 by a CPU loading, into a RAM, a location estimation program recorded in a ROM and executing the location estimation program. The respective functional sections may be implemented by a control circuit included in the mobile object 10. Alternatively, the respective functional sections may be implemented by an information processing apparatus that can communicate with the mobile object 10 wirelessly. Alternatively, a portion of the functional sections may be implemented by a control circuit included in the mobile object 10, and another portion of the function sections may be implemented by an information processing apparatus that can communicate with the mobile object 10 wirelessly.

The location estimation system S1 includes an environment map database 108 that is implemented using a large-capacity nonvolatile storage apparatus such as an HDD or an SSD. When the respective functional sections are implemented by a control circuit included in the mobile object 10, the environment map database 108 may be included in the mobile object 10, or may be included in an information processing apparatus that can communicate with the mobile object 10 wirelessly. When the respective functional sections are implemented by the information processing apparatus that can communicate with the mobile object 10 wirelessly, the environment map database 108 may be included in the information processing apparatus, or may be included in another information processing apparatus that can communicate with the information processing apparatus by which the respective functional sections are implemented.

The sensor assignment section 103 assigns one of the four cameras C1, C2, C3, and C4 as a primary camera 104. The sensor assignment section 103 assigns, as a secondary camera 105, one of the four cameras C1, C2, C3, and C4 that is adjacent to the primary camera 104 and situated on one of sides of the primary camera 104. The sensor assignment section 103 assigns, as a spare camera 106, one of the four cameras C1, C2, C3, and C4 that is adjacent to the primary camera 104 and situated on another of the sides of the primary camera 104.

The environment map generator 107 generates and updates a three-dimensional environment map 115 on the basis of image data (first image-data) (first sensor data) that is acquired by the primary camera 104, image data (second image-data) (second sensor data) that is acquired by the secondary camera 105, and image data (spare image-data) (spare distance-data) that is acquired by the spare camera 106. The environment map 115 includes a plurality of voxels, where the probability of occupation of each of the plurality of voxels is represented in the environment map 115. For example, the environment map 115 is an occupancy grid map (an occupancy map). The occupancy grid map shows a spatial distribution of an object that exists in an environment, using a three-dimensional positional relationship between piled-up voxels (cubes) of a plurality of piled-up voxels (cubes), where the probability of there being the object in each voxel (probability of occupation) is represented by a color of the voxel. Note that, in the environment map 115, the probability of occupation may be represented by a numerical value or a function instead of the color, such that the probability of occupation can be easily used inside of the mobile object 10 or a robot. For example, the probability of occupation is represented by gradations in voxel color, such as using thermography, such that, for example, a voxel having a high probability of occupation is represented by a red area and a voxel having a low probability of occupation is represented by a blue area. The environment map generator 107 stores the generated environment map 115 in the environment map database 108.

The feature point extracting section 109 extracts a feature point from primary image-data acquired by the primary camera 104, extracts a feature point from secondary image-data acquired by the secondary camera 105, and extracts a feature point from spare image-data acquired by the spare camera 106. The feature point extracting section 109 may be implemented by a CPU, or may be implemented by a dedicated vision processor or a GPU.

On the basis of primary image-data acquired by the primary camera 104, the first location estimator 110 estimates a location (a first sensor estimated location) of the mobile object 10 in an occupancy grid map (an environment map) that is stored in the environment map database 108.

On the basis of secondary image-data acquired by the secondary camera 105, the second location estimator 111 estimates a location (a second sensor estimated location) of the mobile object 10 in the occupancy grid map (the environment map) stored in the environment map database 108.

On the basis of distance data acquired by the ranging sensor 101, the third location estimator 112 estimates a location (a ranging sensor estimated location) (a second sensor estimated location) of the mobile object 10 in the occupancy grid map (the environment map) stored in the environment map database 108.

On the basis of internal data (such as angular velocity, acceleration, and/or a rotation angle of the motor) acquired by the internal sensor 102, the fourth location estimator 113 estimates a location of the mobile object 10 in the occupancy grid map (the environment map) stored in the environment map database 108. The internal data (such as angular velocity, acceleration, and/or a rotation angle of the motor) acquired by the internal sensor 102 is used to estimate a displacement measured by odometry (a location estimated on the basis of a rotation of the motor).

The location integration section 114 integrates a primary sensor estimated location generated by the first location estimator 110, a secondary sensor estimated location generated by the second location estimator 111, a ranging sensor estimated location generated by the third location estimator 112, and a displacement measured by odometry and generated by the fourth location estimator 113 to estimate a location and a pose of the mobile object 10 in the occupancy grid map (the environment map).

4. Flow of Operation of Location Estimation System

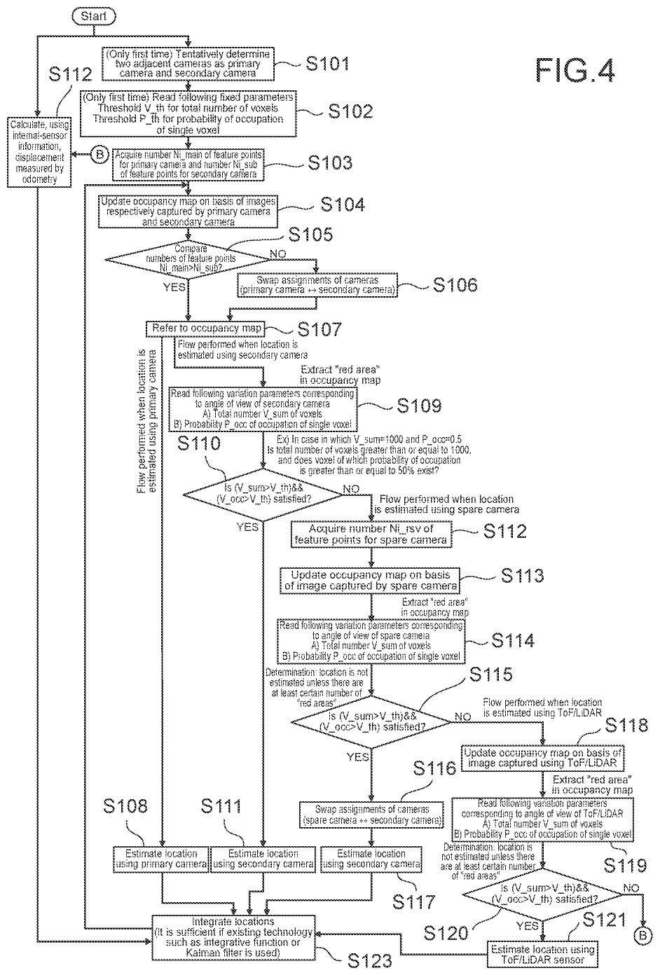

FIG. 4 illustrates a flow of an operation of the location estimation system.

Only the first time, the sensor assignment section 103 assigns one of the four cameras C1, C2, C3, and C4 (for example, the camera C1) as the primary camera 104. The sensor assignment section 103 assigns, as the secondary camera 105, one of the four cameras C1, C2, C3, and C4 (for example, the camera C2) that is adjacent to the primary camera 104 and situated on one of the sides of the primary camera 104 (Step S101).

Only the first time, the sensor assignment section 103 reads a threshold (referred to as a first threshold) V_th for the number of voxels and a threshold (referred to as a second threshold) P_th for the probability of occupation of a voxel (Step S102). The first threshold V_th and the second threshold P_th are fixed parameters. The first threshold V_th is a threshold for a total number of a plurality of voxels situated in a sensing range of a single camera. The second threshold P_th for the probability of occupation is a threshold for the probability of there being an object in a single voxel.

The feature point extracting section 109 extracts a feature point from primary image-data acquired by the primary camera 104 to acquire the number (a total number) Ni_main of feature points included in the primary image-data. The feature point extracting section 109 extracts a feature point from secondary image-data acquired by the secondary camera 105 to acquire the number (a total number) Ni_sub of feature points included in the secondary image-data (Step S103).

The environment map generator 107 generates the three-dimensional environment map 115 (an occupancy grid map) on the basis of the primary image-data acquired by the primary camera 104 and the secondary image-data acquired by the secondary camera 105. The environment map generator 107 stores the generated environment map 115 in the environment map database 108 (Step S104).

The sensor assignment section 103 compares the number Ni_main of feature points included in the primary image-data with the number Ni_sub of feature points included in the secondary image-data (Step S105). It is assumed that the sensor assignment section 103 determines that the number Ni_main of feature points included in the primary image-data is less than or equal to the number Ni_sub of feature points included in the secondary image-data (Step S105, NO). This means that, when a location and a pose of the mobile object 10 in the environment map 115 are estimated on the basis of the primary image-data acquired by the primary camera 104, the estimated location is relatively less reliable. Thus, the sensor assignment section 103 swaps the assignments of the primary camera 104 and the secondary camera 105 (Step S106). For example, when the camera C1 is assigned as the primary camera 104 and the camera C2 is assigned as the secondary camera 105, the sensor assignment section 103 assigns the camera C2 as the primary camera 104 and assigns the camera C1 as the secondary camera 105.

On the other hand, it is assumed that the sensor assignment section 103 determines that the number Ni_main of feature points included in the primary image-data is greater than the number Ni_sub of feature points included in the secondary image-data (Step S105, YES). This means that, when a location and a pose of the mobile object 10 in the environment map 115 are estimated on the basis of the primary image-data acquired by the primary camera 104, the estimated location is relatively highly reliable. Thus, the sensor assignment section 103 does not swap the assignments of the primary camera 104 and the secondary camera 105.

The first location estimator 110 refers to the environment map 115 stored in the environment map database 108 (Step S107). The first location estimator 110 estimates the location and the pose of the mobile object 10 in the environment map 115 on the basis of the primary image-data acquired by the primary camera 104 to generate a primary sensor estimated location (Step S108).

The sensor assignment section 103 refers to the environment map 115 stored in the environment map database 108 (Step S107). The sensor assignment section 103 reads, from the environment map 115, the number (a total number) V_sum of a plurality of voxels situated in a sensing range (a range corresponding to an angle of view) of the secondary camera 105, and the probability P_occ of occupation of each of the plurality of voxels situated in a sensing range (a range corresponding to an angle of view) of the secondary camera 105 that corresponds to a largest detection distance detected by the secondary camera 105 (Step S109). The largest detection distance corresponds to a sensor-specific parameter, and is determined by, for example, a baseline length, the resolution, and an exposure time of a stereo camera module. The number V_sum of voxels and the probability P_occ of occupation are variation parameters that each vary for each sensor (the first camera 104, the secondary camera 105, the spare camera 106, and the ranging sensor 101), and each vary every time the environment map 115 is updated.

The sensor assignment section 103 compares the number V_sum of voxels situated in the sensing range of the secondary camera 105 with the first threshold V_th. The sensor assignment section 103 compares the probability P_occ of occupation of each of the plurality of voxels situated in the sensing range of the secondary camera 105 with the second threshold P_th (Step S110).

It is assumed that the sensor assignment section 103 determines that the number V_sum of voxels situated in the sensing range of the secondary camera 105 is greater than the first threshold V_th and that the probability P_occ of occupation of each of the plurality of voxels situated in the sensing range of the secondary camera 105 is greater than the second threshold P_th (Step S110, YES). This means that, when a location and a pose of the mobile object 10 in the environment map 115 are estimated on the basis of the secondary image-data acquired by the secondary camera 105, the estimated location is relatively highly reliable. Thus, the second location estimator 111 estimates the location and the pose of the mobile object 10 in the environment map 115 on the basis of the secondary image-data acquired by the secondary camera 105 to generate a secondary sensor estimated location (Step S111).

On the other hand, it is assumed that the sensor assignment section 103 determines that the number V_sum of voxels situated in the sensing range of the secondary camera 105 is less than or equal to the first threshold V_th and that the probability P_occ of occupation of each of the plurality of voxels situated in the sensing range of the secondary camera 105 is less than or equal to the second threshold P_th (Step S110, NO). This means that, when a location and a pose of the mobile object 10 in the environment map 115 are estimated on the basis of the secondary image-data acquired by the secondary camera 105, the estimated location is relatively less reliable.

In this case, the sensor assignment section 103 assigns, as the spare camera 106, one of the four cameras C1, C2, C3, and C4 that is adjacent to the primary camera 104 and situated on another of the sides of the primary camera 104. For example, when the camera C1 is assigned as the primary camera 104 and the camera C2 is assigned as the secondary camera 105, the sensor assignment section 103 assigns, as the spare camera 106, the camera C3 adjacent to the primary camera 104 (the camera C1) and situated on the other of the sides of the primary camera 104.

The feature point extracting section 109 extracts a feature point from spare image-data acquired by the spare camera 106 to acquire the number (a total number) Ni_rsv of feature points included in the spare image-data (Step S112).

The environment map generator 107 generates the three-dimensional environment map 115 (an occupancy grid map) on the basis of the spare image-data acquired by the spare camera 106. The environment map generator 107 stores (updates) the generated environment map 115 in the environment map database 108 (Step S113).

The sensor assignment section 103 reads, from the environment map 115 stored in the environment map database 108, the number (a total number) V_sum of a plurality of voxels situated in a sensing range (a range corresponding to an angle of view) of the spare camera 106, and the probability P_occ of occupation of each of the plurality of voxels situated in the sensing range (the range corresponding to the angle of view) of the spare camera 106 (Step S114).

The sensor assignment section 103 compares the number V_sum of voxels situated in the sensing range of the spare camera 106 with the first threshold V_th. The sensor assignment section 103 compares the probability P_occ of occupation of each of the plurality of voxels situated in the sensing range of the spare camera 106 with the second threshold P_th (Step S115).

It is assumed that the sensor assignment section 103 determines that the number V_sum of voxels situated in the sensing range of the spare camera 106 is greater than the first threshold V_th and that the probability P_occ of occupation of each of the plurality of voxels situated in the sensing range of the spare camera 106 is greater than the second threshold P_th (Step S115, YES). This means that, when a location and a pose of the mobile object 10 in the environment map 115 are estimated on the basis of the spare image-data acquired by the spare camera 106, the estimated location is relatively highly reliable.

In this case, the sensor assignment section 103 swaps the assignments of the secondary camera 105 and the spare camera 106 (Step S116). For example, when the camera C2 is assigned as the secondary camera 105 and the camera C3 is assigned as the spare camera 106, the sensor assignment section 103 assigns the camera C3 as the secondary camera 105 and assigns the camera C2 as the spare camera 106.

The second location estimator 111 estimates the location and the pose of the mobile object 10 in the environment map 115 on the basis of the secondary image-data acquired by the newly assigned secondary camera 105 to generate a secondary sensor estimated location (Step S117).

Here, the sensor assignment section 103 may assign a plurality of cameras as the spare cameras 106. In this case, it is sufficient if the sensor assignment section 103 preferentially selects a spare camera 106, from among the plurality of spare cameras 106, that is situated in a direction in which there is an object for which the probability of occupation is high (an estimation value is large) in an occupancy grid in the environment map 115, and newly assigns the selected spare camera 106 as the secondary camera 105. In other words, it is sufficient if a camera that can capture an image of an object for which the probability of occupation is high is situated in a range corresponding to an angle of view of the camera is newly assigned as the secondary camera 105.

On the other hand, it is assumed that the sensor assignment section 103 determines that the number V_sum of voxels situated in the sensing range of the spare camera 106 is less than the first threshold V_th and that the probability P_occ of occupation of each of the plurality of voxels situated in the sensing range of the spare camera 106 is less than the second threshold P_th (Step S115, NO). This means that, when a location and a pose of the mobile object 10 in the environment map 115 are estimated on the basis of the spare image-data acquired by the spare camera 106, the estimated location is relatively less reliable. In this case, the sensor assignment section 103 determines that the secondary camera 105 and the spare camera 106 are not to be used for location estimation.

In this case, the third location estimator 112 generates the three-dimensional environment map 115 (an occupancy grid map) on the basis of distance data acquired by the ranging sensor 101. The environment map generator 107 stores (updates) the generated environment map 115 in the environment map database 108 (Step S118).

The sensor assignment section 103 reads, from the environment map 115 stored in the environment map database 108, the number (a total number) V_sum of a plurality of voxels situated in a sensing range of the ranging sensor 101, and the probability P_occ of occupation of each of the plurality of voxels situated in the sensing range of the spare camera 106 (Step S119).

The sensor assignment section 103 compares the number V_sum of voxels situated in the sensing range of the ranging sensor 101 with the first threshold V_th. The sensor assignment section 103 compares the probability P_occ of occupation of each of the plurality of voxels situated in the sensing range of the ranging sensor 101 with the second threshold P_th (Step S120).

It is assumed that the sensor assignment section 103 determines that the number V_sum of voxels situated in the sensing range of the ranging sensor 101 is greater than the first threshold V_th and that the probability P_occ of occupation of each of the plurality of voxels situated in the sensing range of the ranging sensor 101 is greater than the second threshold P_th (Step S120, YES). This means that, when a location and a pose of the mobile object 10 in the environment map 115 are estimated on the basis of the distance data acquired by the ranging sensor 101, the estimated location is relatively highly reliable. Thus, the third location estimator 112 estimates the location and the pose of the mobile object 10 in the environment map 115 on the basis of the distance data acquired by the ranging sensor 101 to generate a ranging sensor estimated location (a second sensor estimated location) (Step S121).

On the other hand, it is assumed that the sensor assignment section 103 determines that the number V_sum of voxels situated in the sensing range of the ranging sensor 101 is less than the first threshold V_th and that the probability P_occ of occupation of each of the plurality of voxels situated in the sensing range of the ranging sensor 101 is less than the second threshold P_th (Step S120, NO). This means that, when a location and a pose of the mobile object 10 in the environment map 115 are estimated on the basis of the distance data acquired by the ranging sensor 101, the estimated location is relatively less reliable. In this case, the second location estimator 111 does not estimate a secondary sensor estimated location and a pose. Further, the third location estimator 112 does not estimate a ranging sensor estimation.

Here, every time an operation flow is “started”, the fourth location estimator 113 estimates a location and a pose of the mobile object 10 in the environment map 115 stored in the environment map database 108, on the basis of internal data (such as angular velocity, acceleration, and/or a rotation angle of the motor) acquired by the internal sensor 102 to generate a displacement measured by odometry (Step S122).

The location integration section 114 integrates a plurality of generated sensor estimated locations to estimate a location and a pose of the mobile object 10 in the environment map 115 (Step S123). It is sufficient if a technology such as an integrative function or a Kalman filter is used for the integration. integrates the primary sensor estimated location (Step S108), the secondary sensor estimated location (Step S111 or Step S117), and the displacement measured by odometry (Step S122) to estimate the location and the pose of the mobile object 10. Alternatively, when a location estimated on the basis of the secondary sensor estimated location is relatively less reliable (Step S115, NO), the location integration section 114 integrates the primary sensor estimated location (Step S108), the ranging sensor estimated location (Step S121), and the displacement measured by odometry (Step S122) to estimate the location and the pose of the mobile object 10. Alternatively, when a location estimated on the basis of the ranging sensor estimated location is relatively less reliable (Step S120, NO), the location integration section 114 integrates the primary sensor estimated location (Step S108) and the displacement measured by odometry (Step S122) to estimate the location and the pose of the mobile object 10.

Thereafter, the location estimation system S1 continues to generate and store (update) the environment map 115 on the basis of the primary image-data and the secondary image-data (Step S104), and continues to estimate the location and the pose of the mobile object 10 (a loop of Step S123).

As described above, according to the present embodiment, the location estimation system estimates, at all times, a location and a pose on the basis of pieces of data respectively acquired by two cameras (the primary camera 104 and the secondary camera 105) used when relatively highly reliable location estimation is performed and by the internal sensor 102. Thus, the estimation of the location of the mobile object 10 is highly reliable. Further, only two of the four cameras are used, and this results in a reduction in calculation costs. Furthermore, when location estimation performed using the secondary camera 105 is relatively less reliable, a location and a pose are estimated on the basis of pieces of data respectively acquired by the primary camera 104, the ranging sensor 101, and the internal sensor 102. Also in this case, a degree of reliability of the estimation of the location of the mobile object 10 is kept as high as possible, and calculation costs are reduced. Further, when location estimations respectively performed using the secondary camera 105 and the ranging sensor 101 is relatively less reliable, a location and a pose are estimated on the basis of pieces of data respectively acquired by the primary camera 104 and the internal sensor 102. Also in this case, a degree of reliability of the estimation of the location of the mobile object 10 is kept as high as possible, and calculation costs are reduced.

### II. SECOND EMBODIMENT

Hereinafter, descriptions and illustrations of a component and an operation that are similar to the component and the operation described above are omitted, and the description and the illustration are given focused on a point different from that described above.

In the first embodiment, the mobile object 10 includes the four cameras C1, C2, C3, and C4. On the other hand, the mobile object 10 according to a second embodiment includes four ranging sensors (not illustrated). Both the camera (the first embodiment) and the ranging sensor (the second embodiment) are directional, and are sensors that each acquire external data that is used to estimate a location and a pose of the mobile object 10. As in the case of the ranging sensor 101 of the first embodiment, each of the four ranging sensors measures a distance on the basis of a signal received from an environment to acquire distance data. More specifically, the ranging sensor is a sensor (an active sensor) that adopts an approach in which a signal of, for example, an electromagnetic wave, light, or sound is output to an environment to receive a reflected wave. For example, the ranging sensor includes a time-of-flight (ToF) sensor, LiDAR, a millimeter-wave radar, and/or an ultrasonic wave sonar. The four ranging sensors are sensors of the same type and typically have the same specifications, and are equally spaced in plane with each other at intervals of 90 degrees, as illustrated in FIG. 1.

1. Functional Configuration of Location Estimation System

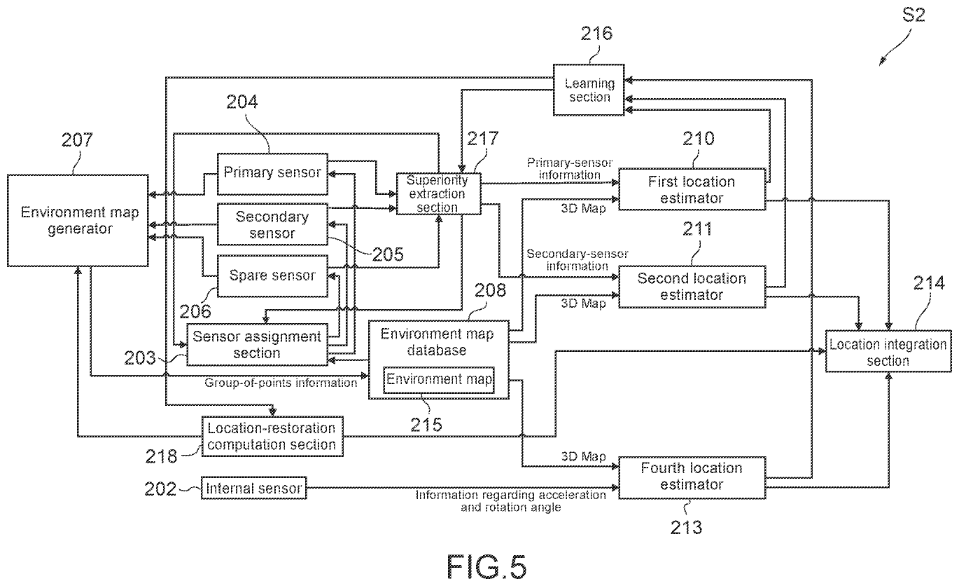

FIG. 5 illustrates a functional configuration of a location estimation system according to the second embodiment of the present disclosure.

The mobile object 10 includes the four ranging sensors (not illustrated) and an internal sensor 202 as built-in hardware sensors.

Each of the four ranging sensors acquires external data used to estimate a location and a pose of the mobile object 10. Each of the four ranging sensors is directional, and acquires distance data used to estimate the location and the pose of the mobile object 10.

The internal sensor 202 acquires internal data used to estimate a location and a pose of the mobile object 10. Specifically, the internal sensor 202 acquires data such as angular velocity, acceleration, and/or a rotation angle of the motor of the mobile object 10. The internal sensor 202 includes, for example, an inertial measurement unit (IMU) and/or a rotation-angle encoder.

A control circuit of a location estimation system S2 operates as a sensor assignment section 203, an environment map generator 207, a first location estimator 210, a second location estimator 211, a fourth location estimator 213, a location integration section 214, a learning section 216, a superiority extraction section 217, and a location-restoration computation section 218 by a CPU loading, into a RAM, a location estimation program recorded in a ROM and executing the location estimation program. The respective functional sections may be implemented by a control circuit included in the mobile object 10. Alternatively, the respective functional sections may be implemented by an information processing apparatus that can communicate with the mobile object 10 wirelessly. Alternatively, a portion of the functional sections may be implemented by a control circuit included in the mobile object 10, and another portion of the function sections may be implemented by an information processing apparatus that can communicate with the mobile object 10 wirelessly.

The location estimation system S2 includes an environment map database 208 that is implemented using a large-capacity nonvolatile storage apparatus such as an HDD or an SSD. When the respective functional sections are implemented by a control circuit included in the mobile object 10, the environment map database 208 may be included in the mobile object 10, or may be included in an information processing apparatus that can communicate with the mobile object 10 wirelessly. When the respective functional sections are implemented by the information processing apparatus that can communicate with the mobile object 10 wirelessly, the environment map database 208 may be included in the information processing apparatus, or may be included in another information processing apparatus that can communicate with the information processing apparatus by which the respective functional sections are implemented.

The sensor assignment section 203 assigns one of the four ranging sensors as a primary sensor 204. The sensor assignment section 203 assigns, as a secondary sensor 205, one of the four ranging sensors that is adjacent to the primary sensor 204 and situated on one of sides of the primary sensor 204. The sensor assignment section 203 assigns, as a spare sensor 206, one of the four ranging sensors that is adjacent to the primary sensor 204 and situated on another of the sides of the primary sensor 204.

The environment map generator 207 generates and updates a three-dimensional environment map 215 on the basis of distance data (first distance-data) (first sensor data) that is acquired by the primary sensor 204, distance data (second distance-data) (second sensor data) that is acquired by the secondary sensor 205, and distance data (spare distance-data) (spare distance-data) that is acquired by the spare sensor 206. The environment map 215 includes a plurality of voxels, where the probability of occupation of each of the plurality of voxels is represented in the environment map 215. For example, the environment map 215 is an occupancy grid map. The occupancy grid map shows a spatial distribution of an object that exists in an environment, using a three-dimensional positional relationship between voxels of a plurality of voxels, where the probability of there being the object in each voxel (probability of occupation) is represented by a color of the voxel. The environment map generator 207 stores the generated environment map 215 in the environment map database 208.

On the basis of primary distance-data acquired by the primary sensor 204, the first location estimator 210 estimates a location (a first sensor estimated location) of the mobile object 10 in an occupancy grid map (an environment map) that is stored in the environment map database 208.

On the basis of secondary distance-data acquired by the secondary sensor 205, the second location estimator 211 estimates a location (a second sensor estimated location) of the mobile object 10 in the occupancy grid map (the environment map) stored in the environment map database 208.

On the basis of internal data (such as angular velocity, acceleration, and/or a rotation angle of the motor) acquired by the internal sensor 202, the fourth location estimator 213 estimates a displacement of the mobile object 10 that is measured by odometry (a location estimated on the basis of a rotation of the motor) in the occupancy grid map (the environment map) stored in the environment map database 208.

The location integration section 214 integrates a primary sensor estimated location generated by the first location estimator 210, a secondary sensor estimated location generated by the second location estimator 211, and a displacement measured by odometry and generated by the fourth location estimator 213 to estimate a location and a pose of the mobile object 10 in the occupancy grid map (the environment map).

The learning section 216 learns a success rate of location estimation that is performed on the basis of the primary distance-data and from which a location is generated by the first location estimator 210, a success rate of location estimation that is performed on the basis of the secondary distance-data and from which a location is generated by the second location estimator 211, and a success rate of location estimation that is performed on the basis of the displacement measured by odometry and generated by the fourth location estimator 213. For example, the learning section 216 performs transaction processing including reading, comparing, and storing the success rates.

The superiority extraction section 217 compares the success rate of location estimation that is performed on the basis of the primary distance-data and from which a location is generated by the first location estimator 210, the success rate of location estimation that is performed on the basis of the secondary distance-data and from which a location is generated by the second location estimator 211, and the success rate of location estimation that is performed on the basis of the displacement measured by odometry and generated by the fourth location estimator 213, and determines the superiority.

When the location estimation fails (a location is lost), the location-restoration computation section 218 restores the location. A success rate of self-location estimation for each sensor is obtained by the learning section storing a sensor that is being used when the self-location estimation has failed (a location is lost). For example, when the self-location estimation performed using a sensor C1 fails, 70%, which is a success rate for the sensor C1, is obtained by subtracting 30% from 100% to be stored as training data. Any percentage may be subtracted, although 30% is subtracted here.

2. Flow of Operation of Location Estimation System

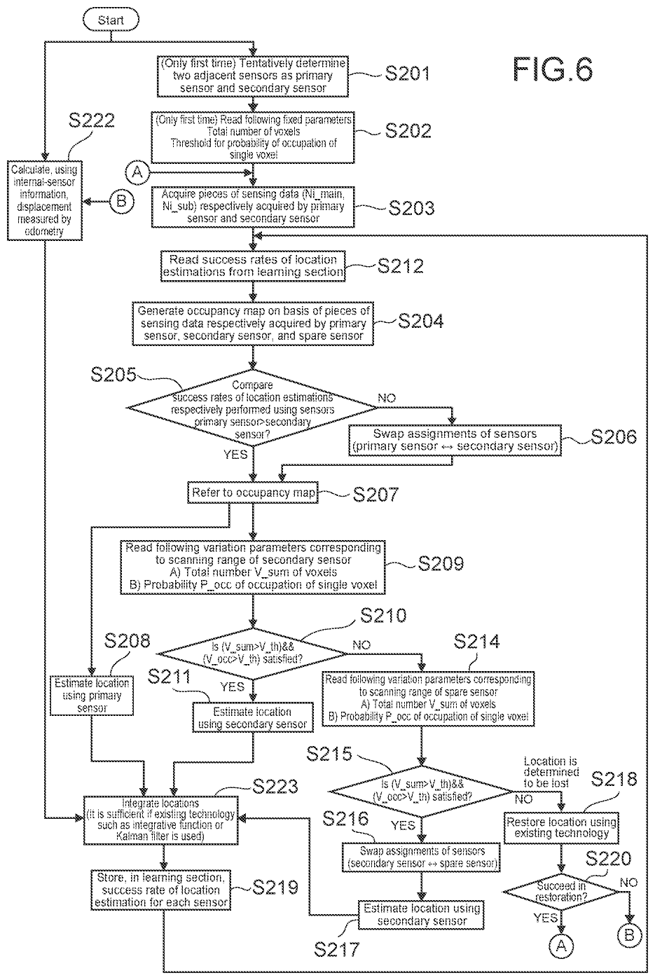

FIG. 6 illustrates a flow of an operation of the location estimation system.

Only the first time, the sensor assignment section 203 assigns one of the four ranging sensors as the primary sensor 204. The sensor assignment section 203 assigns, as the secondary sensor 205, one of the four ranging sensors that is adjacent to the primary sensor 204 and situated on one of the sides of the primary sensor 204 (Step S201). The sensor assignment section 203 assigns, as the spare sensor 206, one of the four ranging sensors that is adjacent to the primary sensor 204 and situated on the other of the sides of the primary sensor 204.

Only the first time, the sensor assignment section 203 reads a threshold (referred to as a first threshold) V_th for the number of voxels and a threshold (referred to as a second threshold) P_th for the probability of occupation of a voxel (Step S202). The first threshold V_th and the second threshold P_th are fixed parameters. The first threshold V_th is a threshold for a total number of a plurality of voxels situated in a sensing range of a single ranging sensor. The second threshold P_th for the probability of occupation is a threshold for the probability of there being an object in a single voxel.

The superiority extraction section 217 acquires primary distance-data acquired by the primary sensor 204, secondary distance-data acquired by the secondary sensor 205, and spare distance-data acquired by the spare sensor 206 (Step S203).

The superiority extraction section 217 reads, from the learning section 216, a success rate of location estimation that is performed on the basis of the primary distance-data and from which a location is generated by the first location estimator 210, and a success rate of location estimation that is performed on the basis of the secondary distance-data and from which a location is generated by the second location estimator 211 (Step S212).

The environment map generator 207 generates the three-dimensional environment map 215 (an occupancy grid map) on the basis of the primary distance-data acquired by the primary sensor 204, the secondary distance-data acquired by the secondary sensor 205, and the spare distance-data acquired by the spare sensor 206. The environment map generator 207 stores the generated environment map 215 in the environment map database 208 (Step S204).

The sensor assignment section 203 compares the success rate of location estimation that is performed on the basis of the primary distance-data and from which a location is generated by the first location estimator 210 with the success rate of location estimation that is performed on the basis of the secondary distance-data and from which a location is generated by the second location estimator 211, the success rates being read by the superiority extraction section 217 from the learning section 216 (Step S205). It is assumed that the sensor assignment section 203 determines that the success rate of location estimation performed on the basis of the primary distance-data is less than or equal to the success rate of location estimation performed on the basis of the secondary distance-data (Step S205, NO). This means that, when a location and a pose of the mobile object 10 in the environment map 115 are estimated on the basis of the primary distance-data acquired by the primary sensor 204, the estimated location is relatively less reliable. Thus, the sensor assignment section 103 swaps the assignments of the primary sensor 204 and the secondary sensor 205 (Step S206).

On the other hand, it is assumed that the sensor assignment section 203 determines that the success rate of location estimation performed on the basis of the primary distance-data is greater than the success rate of location estimation performed on the basis of the secondary distance-data (Step S205, YES). This means that, when a location and a pose of the mobile object 10 in the environment map 115 are estimated on the basis of the primary distance-data acquired by the primary sensor 204, the estimated location is relatively highly reliable. Thus, the sensor assignment section 103 does not swap the assignments of the primary sensor 204 and the secondary sensor 205.

The first location estimator 210 refers to the environment map 215 stored in the environment map database 208 (Step S207). The first location estimator 210 estimates the location and the pose of the mobile object 10 in the environment map 215 on the basis of the primary distance-data acquired by the primary sensor 204 to generate a primary sensor estimated location (Step S208).

The sensor assignment section 203 refers to the environment map 215 stored in the environment map database 208 (Step S207). The sensor assignment section 203 reads, from the environment map 215, the number (a total number) V_sum of a plurality of voxels situated in a sensing range of the secondary sensor 205, and the probability P_occ of occupation of each of the plurality of voxels situated in the sensing range of the secondary sensor 205 (Step S209). The number V_sum of voxels and the probability P_occ of occupation are variation parameters that each vary for each sensor (the primary sensor 204, the secondary sensor 205, and the spare sensor 206), and each vary every time the environment map 215 is updated.

The sensor assignment section 203 compares the number V_sum of voxels situated in the sensing range of the secondary sensor 205 with the first threshold V_th. The sensor assignment section 203 compares the probability P_occ of occupation of each of the plurality of voxels situated in the sensing range of the secondary sensor 205 with the second threshold P_th (Step S210).

It is assumed that the sensor assignment section 203 determines that the number V_sum of voxels situated in the sensing range of the secondary sensor 205 is greater than the first threshold V_th and that the probability P_occ of occupation of each of the plurality of voxels situated in the sensing range of the secondary sensor 205 is greater than the second threshold P_th (Step S210, YES). This means that, when a location and a pose of the mobile object 10 in the environment map 215 are estimated on the basis of the secondary distance-data acquired by the secondary sensor 205, the estimated location is relatively highly reliable. Thus, the second location estimator 211 estimates the location and the pose of the mobile object 10 in the environment map 215 on the basis of the secondary distance-data acquired by the secondary sensor 205 to generate a secondary sensor estimated location (Step S211).

On the other hand, it is assumed that the sensor assignment section 203 determines that the number V_sum of voxels situated in the sensing range of the secondary sensor 205 is less than or equal to the first threshold V_th and that the probability P_occ of occupation of each of the plurality of voxels situated in the sensing range of the secondary sensor 205 is less than or equal to the second threshold P_th (Step S210, NO). This means that, when a location and a pose of the mobile object 10 in the environment map 215 are estimated on the basis of the secondary distance-data acquired by the secondary sensor 205, the estimated location is relatively less reliable.

The sensor assignment section 203 reads, from the environment map 215 stored in the environment map database 208, the number (a total number) V_sum of a plurality of voxels situated in a sensing range of the spare sensor 206, and the probability P_occ of occupation of each of the plurality of voxels situated in the sensing range of the spare sensor 206 (Step S214).

The sensor assignment section 203 compares the number V_sum of voxels situated in the sensing range of the spare sensor 206 with the first threshold V_th. The sensor assignment section 203 compares the probability P_occ of occupation of each of the plurality of voxels situated in the sensing range of the spare sensor 206 with the second threshold P_th (Step S215).

It is assumed that the sensor assignment section 203 determines that the number V_sum of voxels situated in the sensing range of the spare sensor 206 is greater than the first threshold V_th and that the probability P_occ of occupation of each of the plurality of voxels situated in the sensing range of the spare sensor 206 is greater than the second threshold P_th (Step S215, YES). This means that, when a location and a pose of the mobile object 10 in the environment map 215 are estimated on the basis of the spare distance-data acquired by the spare sensor 206, the estimated location is relatively highly reliable.

In this case, the sensor assignment section 203 swaps the assignments of the secondary sensor 205 and the spare sensor 206 (Step S216).

The second location estimator 211 estimates the location and the pose of the mobile object 10 in the environment map 215 on the basis of the secondary distance-data acquired by the newly assigned secondary sensor 205 to generate a secondary sensor estimated location (Step S217).

On the other hand, it is assumed that the sensor assignment section 203 determines that the number V_sum of voxels situated in the sensing range of the spare sensor 206 is less than the first threshold V_th and that the probability P_occ of occupation of each of the plurality of voxels situated in the sensing range of the spare sensor 206 is less than the second threshold P_th (Step S215, NO). This means that, when a location and a pose of the mobile object 10 in the environment map 215 are estimated on the basis of the spare distance-data acquired by the spare sensor 206, the estimated location is relatively less reliable. In this case, the sensor assignment section 203 determines that the secondary sensor 205 and the spare sensor 206 are not to be used for location estimation.

In this case, the location-restoration computation section 218 determines that the location estimation has failed (a location is lost), and restores the location (Step S218). For example, the location-restoration computation section 218 estimates the location of the mobile object 10 again using distance data obtained a few seconds ago. When the location-restoration computation section 218 has succeeded in restoring the location (Step S220, YES), the location estimation system S2 generates and stores (updates) the environment map 215 (Step S204). On the other hand, when the location-restoration computation section 218 has failed in restoring the location (Step S220, NO), a location generated by the location-restoration computation section 218 is not used.

Here, every time an operation flow is “started”, the fourth location estimator 213 estimates a location and a pose of the mobile object 10 in the environment map 215 stored in the environment map database 208, on the basis of internal data (such as angular velocity, acceleration, and/or a rotation angle of the motor) acquired by the internal sensor 102 to generate a displacement measured by odometry (Step S222).

The location integration section 214 integrates a plurality of generated sensor estimated locations to estimate a location and a pose of the mobile object 10 in the environment map 215 (Step S223). Specifically, the location integration section 214 integrates the primary sensor estimated location (Step S208), the secondary sensor estimated location (Step S211 or Step S217), and the displacement measured by odometry (Step S222) to estimate the location and the pose of the mobile object 10. Alternatively, when a location estimated on the basis of the secondary sensor estimated location is relatively less reliable (Step S215, NO), the location integration section 214 integrates the primary sensor estimated location (Step S208), the location restored by the location-restoration computation section 218 (Step S218), and the displacement measured by odometry (Step S222) to estimate the location and the pose of the mobile object 10. Alternatively, when the location-restoration computation section 218 has failed in restoring the location (Step S220, NO), the location integration section 214 integrates the primary sensor estimated location (Step S208) and the displacement measured by odometry (Step S222) to estimate the location and the pose of the mobile object 10.

The learning section 216 acquires the primary sensor estimated location generated by the first location estimator 210 (Step S208), the secondary sensor estimated location generated by the second location estimator 211 (Step S211 or Step S217), and the displacement measured by odometry and generated by the fourth location estimator 213 (Step S222). The learning section 216 learns and stores the success rate of location estimation that is performed on the basis of the primary distance-data and from which a location is generated by the first location estimator 210, the success rate of location estimation that is performed on the basis of the secondary distance-data and from which a location is generated by the second location estimator 211, and the success rate of location estimation that is performed on the basis of the displacement measured by odometry and generated by the fourth location estimator 213 (Step S219).

Thereafter, the location estimation system S2 continues to generate and store (update) the environment map 215 on the basis of the primary distance-data and the secondary distance-data (Step S204), and continues to estimate the location and the pose of the mobile object 10 (a loop of Step S219).

As described above, according to the present embodiment, the location estimation system estimates, at all times, a location and a pose on the basis of pieces of data respectively acquired by two ranging sensors (the primary sensor 204 and the secondary sensor 205) used when relatively highly reliable location estimation is performed and by the internal sensor 102. Thus, the estimation of the location of the mobile object 10 is highly reliable. Further, only two of the four ranging sensors are used, and this results in a reduction in calculation costs. Furthermore, when location estimation performed using the secondary sensor 205 is relatively less reliable, a location and a pose are estimated on the basis of data acquired by the primary sensor 204, a location restored by the location-restoration computation section 218, and data acquired by the internal sensor 102. Also in this case, a degree of reliability of the estimation of the location of the mobile object 10 is kept as high as possible, and calculation costs are reduced. Further, when location estimation performed using the secondary sensor 205 and a location restored by the location-restoration computation section 218 are relatively less reliable, a location and a pose are estimated on the basis of pieces of data respectively acquired by the primary sensor 204 and the internal sensor 102. Also in this case, a degree of reliability of the estimation of the location of the mobile object 10 is kept as high as possible, and calculation costs are reduced.

### III. THIRD EMBODIMENT

In the first embodiment, the location estimation system S1 determines a camera that is to be used for location estimation, on the basis of comparison of the numbers of feature points (Step S105) and on the basis of how reliable an estimated location of the mobile object 10 in the environment map 115 is (Steps S110 and S115). On the other hand, in a third embodiment, the location estimation system S1 determines a camera that is to be used for location estimation, on the basis of only the number of feature points.

A functional configuration of the location estimation system S1 of the third embodiment is similar to the functional configuration of the location estimation system S1 of the first embodiment (FIG. 3), and thus is not illustrated.

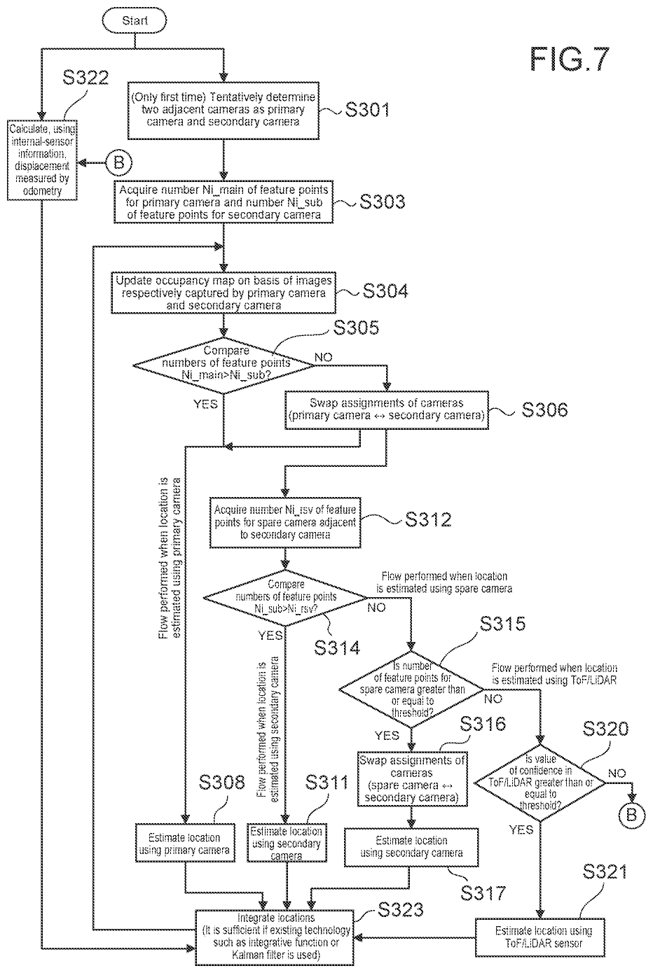

FIG. 7 illustrates a flow of the operation of the location estimation system according to the third embodiment of the present disclosure.

Only the first time, the sensor assignment section 103 assigns one of the four cameras C1, C2, C3, and C4 (for example, the camera C1) as the primary camera 104. The sensor assignment section 103 assigns, as the secondary camera 105, one of the four cameras C1, C2, C3, and C4 (for example, the camera C2) that is adjacent to the primary camera 104 and situated on one of the sides of the primary camera 104 (Step S301).

The feature point extracting section 109 extracts a feature point from primary image-data acquired by the primary camera 104 to acquire the number (a total number) Ni_main of feature points included in the primary image-data. The feature point extracting section 109 extracts a feature point from secondary image-data acquired by the secondary camera 105 to acquire the number (a total number) Ni_sub of feature points included in the secondary image-data (Step S303).

The environment map generator 107 generates the three-dimensional environment map 115 (an occupancy grid map) on the basis of the primary image-data acquired by the primary camera 104 and the secondary image-data acquired by the secondary camera 105. The environment map generator 107 stores the generated environment map 115 in the environment map database 108 (Step S304).

The sensor assignment section 103 compares the number Ni_main of feature points included in the primary image-data with the number Ni_sub of feature points included in the secondary image-data (Step S305). It is assumed that the sensor assignment section 103 determines that the number Ni_main of feature points included in the primary image-data is less than or equal to the number Ni_sub of feature points included in the secondary image-data (Step S305, NO). This means that, when a location and a pose of the mobile object 10 in the environment map 115 are estimated on the basis of the primary image-data acquired by the primary camera 104, the estimated location is relatively less reliable. Thus, the sensor assignment section 103 swaps the assignments of the primary camera 104 and the secondary camera 105 (Step S306). For example, when the camera C1 is assigned as the primary camera 104 and the camera C2 is assigned as the secondary camera 105, the sensor assignment section 103 assigns the camera C2 as the primary camera 104 and assigns the camera C1 as the secondary camera 105.

On the other hand, it is assumed that the sensor assignment section 103 determines that the number Ni_main of feature points included in the primary image-data is greater than the number Ni_sub of feature points included in the secondary image-data (Step S305, YES). This means that, when a location and a pose of the mobile object 10 in the environment map 115 are estimated on the basis of the primary image-data acquired by the primary camera 104, the estimated location is relatively highly reliable. Thus, the sensor assignment section 103 does not swap the assignments of the primary camera 104 and the secondary camera 105.

The first location estimator 110 estimates the location and the pose of the mobile object 10 in the environment map 115 on the basis of the primary image-data acquired by the primary camera 104 to generate a primary sensor estimated location (Step S308).

The sensor assignment section 103 assigns, as the spare camera 106, one of the four cameras C1, C2, C3, and C4 that is adjacent to the primary camera 104 and situated on another of the sides of the primary camera 104. For example, when the camera C1 is assigned as the primary camera 104 and the camera C2 is assigned as the secondary camera 105, the sensor assignment section 103 assigns, as the spare camera 106, the camera C3 adjacent to the primary camera 104 (the camera C1) and situated on the other of the sides of the primary camera 104.

The feature point extracting section 109 extracts a feature point from spare image-data acquired by the spare camera 106 to acquire the number (a total number) Ni_rsv of feature points included in the spare image-data (Step S312).

The sensor assignment section 103 compares the number Ni_sub of feature points included in the secondary image-data with the number Ni_rsv of feature points included in the spare image-data (Step S314). When the sensor assignment section 103 determines that the number Ni_sub of feature points included in the secondary image-data is greater than the number Ni_rsv of feature points included in the spare image-data (Step S314, YES), the sensor assignment section 103 does not swap the assignments of the secondary camera 105 and the spare camera 106. This means that location estimation performed when a location and a pose of the mobile object 10 in the environment map 115 are estimated on the basis of the secondary image-data acquired by the secondary camera 105, is more reliable than location estimation performed when the location and the pose of the mobile object 10 in the environment map 115 are estimated on the basis of the secondary spare data acquired by the spare camera 106. Thus, the second location estimator 111 estimates the location and the pose of the mobile object 10 in the environment map 115 on the basis of the secondary image-data acquired by the secondary camera 105 to generate a secondary sensor estimated location (Step S311).

On the other hand, it is assumed that the sensor assignment section 103 determines that the number Ni_sub of feature points included in the secondary image-data is less than or equal to the number Ni_rsv of feature points included in the spare image-data (Step S305, NO). This means that, when a location and a pose of the mobile object 10 in the environment map 115 are estimated on the basis of the secondary image-data acquired by the secondary camera 105, the estimated location is relatively less reliable. In this case, the sensor assignment section 103 determines whether the number Ni_rsv of feature points included in the spare image-data is greater than or equal to a third threshold (Step S315). The third threshold corresponds to a total number of feature points necessary for an estimated location to exhibit a degree of reliability greater than or equal to a specified degree of reliability.

It is assumed that the sensor assignment section 103 determines that the number Ni_rsv of feature points included in the spare image-data is greater than or equal to the third threshold (Step S315, YES). This means that, when a location and a pose of the mobile object 10 in the environment map 115 are estimated on the basis of the spare image-data acquired by the spare camera 106, the estimated location is relatively highly reliable.

In this case, the sensor assignment section 103 swaps the assignments of the secondary camera 105 and the spare camera 106 (Step S316). For example, when the camera C2 is assigned as the secondary camera 105 and the camera C3 is assigned as the spare camera 106, the sensor assignment section 103 assigns the camera C3 as the secondary camera 105 and assigns the camera C2 as the spare camera 106.

The second location estimator 111 estimates the location and the pose of the mobile object 10 in the environment map 115 on the basis of the secondary image-data acquired by the newly assigned secondary camera 105 to generate a secondary sensor estimated location (Step S317).

On the other hand, it is assumed that the sensor assignment section 103 determines that the number Ni_rsv of feature points included in the spare image-data is less than the third threshold (Step S315, NO). This means that, when a location and a pose of the mobile object 10 in the environment map 115 are estimated on the basis of the spare image-data acquired by the spare camera 106, the estimated location is relatively less reliable. In this case, the sensor assignment section 103 determines that the secondary camera 105 and the spare camera 106 are not to be used for location estimation.

In this case, the sensor assignment section 103 determines whether a degree of reliability of the ranging sensor 101 is greater than or equal to a fifth threshold (Step S320). The degree of reliability of the ranging sensor 101 is based on, for example, a success rate of location estimation performed using the ranging sensor 101. The fifth threshold is a threshold used to determine whether a location estimated using the ranging sensor 101 exhibits a degree of reliability greater than or equal to a specified degree of reliability. It is assumed that the sensor assignment section 103 determines that the degree of reliability of the ranging sensor 101 is greater than or equal to the fifth threshold (Step S320, YES). This means that, when a location and a pose of the mobile object 10 in the environment map 115 are estimated on the basis of the distance data acquired by the ranging sensor 101, the estimated location is relatively highly reliable. Thus, the third location estimator 112 estimates the location and the pose of the mobile object 10 in the environment map 115 on the basis of the distance data acquired by the ranging sensor 101 to generate a ranging sensor estimated location (a second sensor estimated location) (Step S321).

On the other hand, it is assumed that the sensor assignment section 103 determines that the degree of the ranging sensor 101 is less than the fifth threshold (Step S320, NO). This means that, when a location and a pose of the mobile object 10 in the environment map 115 are estimated on the basis of the distance data acquired by the ranging sensor 101, the estimated location is relatively less reliable. In this case, the second location estimator 111 does not estimate a secondary sensor estimated location. Further, the third location estimator 112 does not estimate a ranging sensor estimated location.

Here, every time an operation flow is “started”, the fourth location estimator 113 estimates a location and a pose of the mobile object 10 in the environment map 115 stored in the environment map database 108, on the basis of internal data (such as angular velocity, acceleration, and/or a rotation angle of the motor) acquired by the internal sensor 102 to generate a displacement measured by odometry (Step S322).

The location integration section 114 integrates a plurality of generated sensor estimated locations to estimate a location and a pose of the mobile object 10 in the environment map 115 (Step S323). integrates the primary sensor estimated location (Step S308), the secondary sensor estimated location (Step S311 or Step S317), and the displacement measured by odometry (Step S322) to estimate the location and the pose of the mobile object 10. Alternatively, when a location estimated on the basis of the secondary sensor estimated location is relatively less reliable (Step S315, NO), the location integration section 114 integrates the primary sensor estimated location (Step S308), the ranging sensor estimated location (Step S321), and the displacement measured by odometry (Step S322) to estimate the location and the pose of the mobile object 10. Alternatively, when a location estimated on the basis of the ranging sensor estimated location is relatively less reliable (Step S320, NO), the location integration section 114 integrates the primary sensor estimated location (Step S308) and the displacement measured by odometry (Step S322) to estimate the location and the pose of the mobile object 10.

Thereafter, the location estimation system S1 continues to generate and store (update) the environment map 115 on the basis of the primary image-data and the secondary image-data (Step S304), and continues to estimate the location and the pose of the mobile object 10 (a loop of Step S323).

As described above, according to the present embodiment, the location estimation system estimates, at all times, a location and a pose on the basis of pieces of data respectively acquired by two cameras (the primary camera 104 and the secondary camera 105) used when relatively highly reliable location estimation is performed and by the internal sensor 102. Thus, the estimation of the location of the mobile object 10 is highly reliable. Further, only two of the four cameras are used, and this results in a reduction in calculation costs. Furthermore, when location estimation performed using the secondary camera 105 is relatively less reliable, a location and a pose are estimated on the basis of pieces of data respectively acquired by the primary camera 104, the ranging sensor 101, and the internal sensor 102. Also in this case, a degree of reliability of the estimation of the location of the mobile object 10 is kept as high as possible, and calculation costs are reduced. Further, when location estimations respectively performed using the secondary camera 105 and the ranging sensor 101 is relatively less reliable, a location and a pose are estimated on the basis of pieces of data respectively acquired by the primary camera 104 and the internal sensor 102. Also in this case, a degree of reliability of the estimation of the location of the mobile object 10 is kept as high as possible, and calculation costs are reduced. Further, in the third embodiment, the location estimation system S1 determines a camera that is to be used for location estimation, on the basis of only the number of feature points. This results in a further reduction in calculation costs, compared to the first embodiment.

### IV. FOURTH EMBODIMENT

In the second embodiment, the location estimation system S2 determines a camera that is to be used for location estimation, on the basis of comparison of successes of location estimations (Step S205) and on the basis of how reliable an estimated location of the mobile object 10 in the environment map 115 is (Steps S210 and S215). On the other hand, in a third embodiment, the location estimation system S2 determines a camera that is to be used for location estimation, on the basis of only the success of location estimation.

A functional configuration of the location estimation system S2 of the fourth embodiment is similar to the functional configuration of the location estimation system S2 of the second embodiment (FIG. 5), and thus is not illustrated.

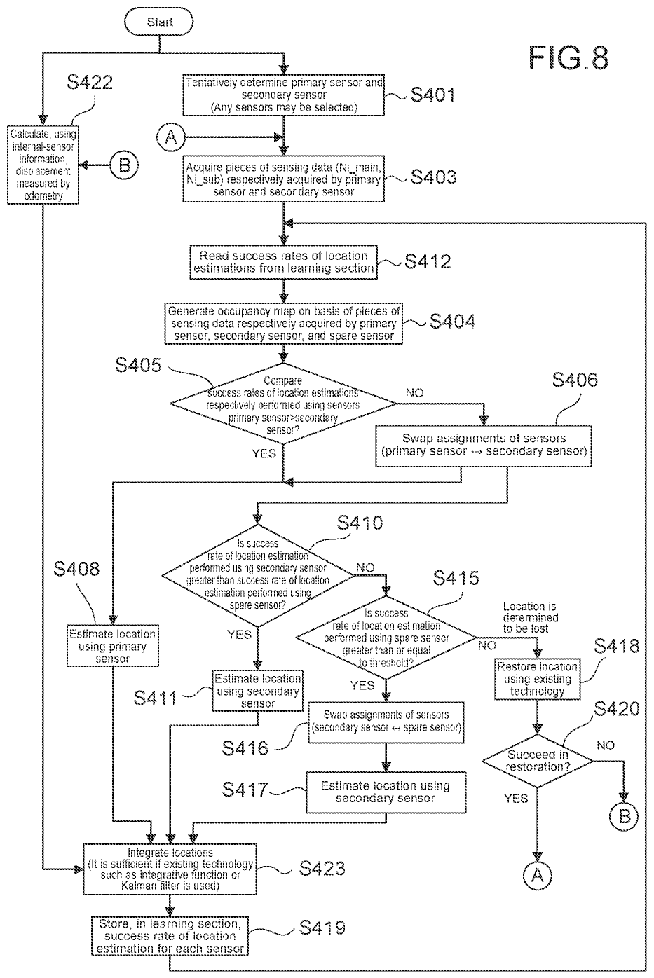

FIG. 8 illustrates a flow of the operation of the location estimation system according to the fourth embodiment of the present disclosure.

Only the first time, the sensor assignment section 203 assigns one of the four ranging sensors as the primary sensor 204. The sensor assignment section 203 assigns, as the secondary sensor 205, one of the four ranging sensors that is adjacent to the primary sensor 204 and situated on one of the sides of the primary sensor 204 (Step S401). The sensor assignment section 203 assigns, as the spare sensor 206, one of the four ranging sensors that is adjacent to the primary sensor 204 and situated on the other of the sides of the primary sensor 204.

The superiority extraction section 217 acquires primary distance-data acquired by the primary sensor 204, secondary distance-data acquired by the secondary sensor 205, and spare distance-data acquired by the spare sensor 206 (Step S403).

The superiority extraction section 217 reads, from the learning section 216, a success rate of location estimation that is performed on the basis of the primary distance-data and from which a location is generated by the first location estimator 210, and a success rate of location estimation that is performed on the basis of the secondary distance-data and from which a location is generated by the second location estimator 211 (Step S412).

The environment map generator 207 generates the three-dimensional environment map 215 (an occupancy grid map) on the basis of the primary distance-data acquired by the primary sensor 204, the secondary distance-data acquired by the secondary sensor 205, and the spare distance-data acquired by the spare sensor 206. The environment map generator 207 stores the generated environment map 215 in the environment map database 208 (Step S404).

The sensor assignment section 203 compares the success rate of location estimation that is performed on the basis of the primary distance-data and from which a location is generated by the first location estimator 210 with the success rate of location estimation that is performed on the basis of the secondary distance-data and from which a location is generated by the second location estimator 211, the success rates being read by the superiority extraction section 217 from the learning section 216 (Step S405). It is assumed that the sensor assignment section 203 determines that the success rate of location estimation performed on the basis of the primary distance-data is less than or equal to the success rate of location estimation performed on the basis of the secondary distance-data (Step S405, NO). This means that, when a location and a pose of the mobile object 10 in the environment map 115 are estimated on the basis of the primary distance-data acquired by the primary sensor 204, the estimated location is relatively less reliable. Thus, the sensor assignment section 103 swaps the assignments of the primary sensor 204 and the secondary sensor 205 (Step S406).

On the other hand, it is assumed that the sensor assignment section 203 determines that the success rate of location estimation performed on the basis of the primary distance-data is greater than the success rate of location estimation performed on the basis of the secondary distance-data (Step S405, YES). This means that, when a location and a pose of the mobile object 10 in the environment map 115 are estimated on the basis of the primary distance-data acquired by the primary sensor 204, the estimated location is relatively highly reliable. Thus, the sensor assignment section 103 does not swap the assignments of the primary sensor 204 and the secondary sensor 205.

The first location estimator 210 estimates the location and the pose of the mobile object 10 in the environment map 215 on the basis of the primary distance-data acquired by the primary sensor 204 to generate a primary sensor estimated location (Step S408).

The superiority extraction section 217 reads, from the learning section 216, a success rate of location estimation that is performed on the basis of the spare distance-data acquired by the spare sensor 206. In particular, the superiority extraction section 217 reads, from the learning section 216, a success rate of location estimation performed using a certain ranging sensor when the certain ranging sensor has been assigned as the primary sensor 204 or the secondary sensor 205, the certain ranging sensor being currently assigned as the spare sensor 206.

The sensor assignment section 203 compares the success rate of location estimation performed on the basis of the spare distance-data with the success rate of location estimation performed on the basis of the secondary distance-data, the success rates being read by the superiority extraction section 217 from the learning section 216 (Step S410).

It is assumed that the sensor assignment section 203 determines that the success rate of location estimation performed on the basis of the secondary distance-data is greater than the success rate of location estimation performed on the basis of the spare distance-data (Step S410, YES). This means that, when a location and a pose of the mobile object 10 in the environment map 215 are estimated on the basis of the secondary distance-data acquired by the secondary sensor 205, the estimated location is relatively highly reliable. Thus, the second location estimator 211 estimates the location and the pose of the mobile object 10 in the environment map 215 on the basis of the secondary distance-data acquired by the secondary sensor 205 to generate a secondary sensor estimated location (Step S411).

On the other hand, it is assumed that the sensor assignment section 203 determines that the success rate of location estimation performed on the basis of the secondary distance-data is less than or equal to the success rate of location estimation performed on the basis of the spare distance-data (Step S410, NO). This means that, when a location and a pose of the mobile object 10 in the environment map 215 are estimated on the basis of the secondary distance-data acquired by the secondary sensor 205, the estimated location is relatively less reliable. In this case, the sensor assignment section 203 determines whether the success rate of location estimation performed on the basis of the spare distance-data is greater than or equal to a fourth threshold (Step S415). The fourth threshold is a threshold used to determine whether an estimated location exhibits a degree of reliability greater than or equal to a specified degree of reliability.

It is assumed that the sensor assignment section 203 determines that the success rate of location estimation performed on the basis of the spare distance-data is greater than or equal to the fourth threshold (Step S415, YES). This means that, when a location and a pose of the mobile object 10 in the environment map 215 are estimated on the basis of the spare distance-data acquired by the spare sensor 206, the estimated location is relatively highly reliable.

In this case, the sensor assignment section 203 swaps the assignments of the secondary sensor 205 and the spare sensor 206 (Step S416).

The second location estimator 211 estimates the location and the pose of the mobile object 10 in the environment map 215 on the basis of the secondary distance-data acquired by the newly assigned secondary sensor 205 to generate a secondary sensor estimated location (Step S417).

On the other hand, it is assumed that the sensor assignment section 203 determines that the success rate of location estimation performed on the basis of the spare distance-data is less than the fourth threshold (Step S415, NO). This means that, when a location and a pose of the mobile object 10 in the environment map 215 are estimated on the basis of the spare distance-data acquired by the spare sensor 206, the estimated location is relatively less reliable. In this case, the sensor assignment section 203 determines that the secondary sensor 205 and the spare sensor 206 are not to be used for location estimation.

In this case, the location-restoration computation section 218 determines that the location estimation has failed (a location is lost), and restores the location (Step S418). For example, the location-restoration computation section 218 estimates the location of the mobile object 10 again using distance data obtained a few seconds ago. When the location-restoration computation section 218 has succeeded in restoring the location (Step S420, YES), the location estimation system S2 generates and stores (updates) the environment map 215 (Step S404). On the other hand, when the location-restoration computation section 218 has failed in restoring the location (Step S420, NO), a location generated by the location-restoration computation section 218 is not used.

Here, every time an operation flow is “started”, the fourth location estimator 213 estimates a location and a pose of the mobile object 10 in the environment map 215 stored in the environment map database 208, on the basis of internal data (such as angular velocity, acceleration, and/or a rotation angle of the motor) acquired by the internal sensor 102 to generate a displacement measured by odometry (Step S422).

The location integration section 214 integrates a plurality of generated sensor estimated locations to estimate a location and a pose of the mobile object 10 in the environment map 215 (Step S423). Specifically, the location integration section 214 integrates the primary sensor estimated location (Step S408), the secondary sensor estimated location (Step S411 or Step S417), and the displacement measured by odometry (Step S422) to estimate the location and the pose of the mobile object 10. Alternatively, when a location estimated on the basis of the secondary sensor estimated location is relatively less reliable (Step S415, NO), the location integration section 214 integrates the primary sensor estimated location (Step S408), the location restored by the location-restoration computation section 218 (Step S418), and the displacement measured by odometry (Step S422) to estimate the location and the pose of the mobile object 10. Alternatively, when the location-restoration computation section 218 has failed in restoring the location (Step S420, NO), the location integration section 214 integrates the primary sensor estimated location (Step S408) and the displacement measured by odometry (Step S422) to estimate the location and the pose of the mobile object 10.

The learning section 216 acquires the primary sensor estimated location generated by the first location estimator 210 (Step S408), the secondary sensor estimated location generated by the second location estimator 211 (Step S411 or Step S417), and the displacement measured by odometry and generated by the fourth location estimator 213 (Step S422). The learning section 216 learns and stores the success rate of location estimation that is performed on the basis of the primary distance-data and from which a location is generated by the first location estimator 210, the success rate of location estimation that is performed on the basis of the secondary distance-data and from which a location is generated by the second location estimator 211, and the success rate of location estimation that is performed on the basis of the displacement measured by odometry and generated by the fourth location estimator 213 (Step S419).

Thereafter, the location estimation system S2 continues to generate and store (update) the environment map 215 on the basis of the primary distance-data and the secondary distance-data (Step S404), and continues to estimate the location and the pose of the mobile object 10 (a loop of Step S419).

As described above, according to the present embodiment, the location estimation system estimates, at all times, a location and a pose on the basis of pieces of data respectively acquired by two ranging sensors (the primary sensor 204 and the secondary sensor 205) used when relatively highly reliable location estimation is performed and by the internal sensor 102. Thus, the estimation of the location of the mobile object 10 is highly reliable. Further, only two of the four ranging sensors are used, and this results in a reduction in calculation costs. Furthermore, when location estimation performed using the secondary sensor 205 is relatively less reliable, a location and a pose are estimated on the basis of data acquired by the primary sensor 204, a location restored by the location-restoration computation section 218, and data acquired by the internal sensor 102. Also in this case, a degree of reliability of the estimation of the location of the mobile object 10 is kept as high as possible, and calculation costs are reduced. Further, when location estimation performed using the secondary sensor 205 and a location restored by the location-restoration computation section 218 are relatively less reliable, a location and a pose are estimated on the basis of pieces of data respectively acquired by the primary sensor 204 and c. Also in this case, a degree of reliability of the estimation of the location of the mobile object 10 is kept as high as possible, and calculation costs are reduced. Further, in the fourth embodiment, the location estimation system S2 determines a camera that is to be used for location estimation, on the basis of only the number of success rates of location estimation. This results in a further reduction in calculation costs, compared to the second embodiment.

### V. FIRST MODIFICATION

When the secondary camera 105 does not satisfy a first condition and the spare camera 106 satisfies a second condition, it is sufficient if the sensor assignment section 103 swaps the assignments of the secondary camera 105 and the spare camera 106. This is a modification of the first embodiment and the third embodiment.

When the number of feature points included in secondary image-data is less than or equal to the number of feature points included in spare image-data, and/or when the number of a plurality of voxels situated in a sensing range of the secondary camera 105 is less than or equal to the first threshold and the probability of occupation of each of the plurality of voxels situated in the sensing range of the secondary camera 105 is less than or equal to the second threshold, it is sufficient if the sensor assignment section 103 determines that the secondary camera 105 does not satisfy the first condition.

In other words, the sensor assignment section 103 determines, in the third embodiment, that the case in which the number of feature points included in secondary image-data is less than or equal to the number of feature points included in spare image-data (Step S314 in FIG. 7) is the case in which the secondary camera 105 does not satisfy the first condition. On the other hand, the sensor assignment section 103 determines, in the first embodiment, that the case in which the number of a plurality of voxels situated in a sensing range of the secondary camera 105 is less than or equal to the first threshold and the probability of occupation of each of the plurality of voxels situated in the sensing range of the secondary camera 105 is less than or equal to the second threshold (Step S110 in FIG. 4) is the case in which the secondary camera 105 does not satisfy the first condition. In other words, only one of the conditions is adopted. Instead, the case in which both of the conditions are satisfied may be determined to be the case in which the secondary camera 105 does not satisfy the first condition.

When the number of feature points included in spare image-data is greater than or equal to the third threshold, and/or when the number of a plurality of voxels situated in a sensing range of the spare camera 106 is greater than the first threshold and the probability of occupation of each of the plurality of voxels situated in the sensing range of the spare camera 106 is greater than the second threshold, it is sufficient if the sensor assignment section 103 determines that the spare camera 106 satisfies the second condition.

In other words, the sensor assignment section 103 determines, in the third embodiment, that the case in which the number of feature points included in spare image-data is greater than or equal to the third threshold (Step S315 in FIG. 7) is the case in which the spare camera 106 satisfies the second condition. On the other hand, the sensor assignment section 103 determines, in the first embodiment, that the case in which the number of a plurality of voxels situated in a sensing range of the spare camera 106 is greater than the first threshold and the probability of occupation of each of the plurality of voxels situated in the sensing range of the spare camera 106 is greater than the second threshold (Step S115 in FIG. 4) is the case in which the spare camera 106 satisfies the second condition. In other words, only one of the conditions is adopted. Instead, the case in which both of the conditions are satisfied may be determined to be the case in which the spare camera 106 satisfies the second condition.

### VI. SECOND MODIFICATION

When the secondary sensor 205 does not satisfy a first condition and the spare sensor 206 satisfies a second condition, it is sufficient if the sensor assignment section 203 swaps the assignments of the secondary sensor 205 and the spare sensor 206. This is a modification of the second embodiment and the fourth embodiment.

When a success rate of location estimation performed on the basis of secondary distance-data is less than or equal to a success rate of location estimation performed on the basis of spare distance-data, and/or when the number of a plurality of voxels situated in a sensing range of the secondary sensor 205 is less than or equal to the first threshold and the probability of occupation of each of the plurality of voxels situated in the sensing range of the secondary sensor 205 is less than or equal to the second threshold, it is sufficient if the sensor assignment section 203 determines that the secondary sensor 205 does not satisfy the first condition.

In other words, the sensor assignment section 203 determines, in the fourth embodiment, that the case in which the success rate of location estimation performed on the basis of secondary distance-data is less than or equal to the success rate of location estimation performed on the basis of spare distance-data (Step S410 in FIG. 8) is the case in which the secondary sensor 205 does not satisfy the first condition. On the other hand, the sensor assignment section 103 determines, in the second embodiment, that the case in which the number of a plurality of voxels situated in a sensing range of the secondary sensor 205 is less than or equal to the first threshold and the probability of occupation of each of the plurality of voxels situated in the sensing range of the secondary sensor 205 is less than or equal to the second threshold (Step S210 in FIG. 6) is the case in which the secondary sensor 205 does not satisfy the first condition. In other words, only one of the conditions is adopted. Instead, the case in which both of the conditions are satisfied may be determined to be the case in which the secondary sensor 205 does not satisfy the first condition.

When the success rate of location estimation performed on the basis of spare distance-data is greater than or equal to the fourth threshold, and/or when the number of a plurality of voxels situated in a sensing range of the spare sensor 206 is greater than the first threshold and the probability of occupation of each of the plurality of voxels situated in the sensing range of the spare sensor 206 is greater than the second threshold, it is sufficient if the sensor assignment section 203 determines that the spare sensor 206 satisfies the second condition.

In other words, the sensor assignment section 203 determines, in the fourth embodiment, that the case in which the success rate of location estimation performed on the basis of spare distance-data is greater than or equal to the fourth threshold (Step S415 in FIG. 8) is the case in which the spare sensor 206 satisfies the second condition. On the other hand, the sensor assignment section 203 determines, in the second embodiment, that the case in which the number of a plurality of voxels situated in a sensing range of the spare sensor 206 is greater than the first threshold and the probability of occupation of each of the plurality of voxels situated in the sensing range of the spare sensor 206 is greater than the second threshold (Step S215 in FIG. 6) is the case in which the spare sensor 206 satisfies the second condition. In other words, only one of the conditions is adopted. Instead, the case in which both of the conditions are satisfied may be determined to be the case in which the spare sensor 206 satisfies the second condition.

### VII. THIRD MODIFICATION

When the secondary camera 105 does not satisfy a first condition and the spare camera 106 does not satisfy a second condition, it is sufficient if the sensor assignment section 103 determines that the secondary camera 105 and the spare camera 106 are not to be used for location estimation. This is a modification of the first embodiment and the third embodiment.

When the number of feature points included in spare image-data is less than the third threshold, and/or when the number of a plurality of voxels situated in a sensing range of the spare camera 106 is less than or equal to the first threshold and the probability of occupation of each of the plurality of voxels situated in the sensing range of the spare camera 106 is less than or equal to the second threshold, it is sufficient if the sensor assignment section 103 determines that the spare camera 106 does not satisfy the second condition.

In other words, the sensor assignment section 103 determines, in the third embodiment, that the case in which the number of feature points included in spare image-data is less than the third threshold (Step S315 in FIG. 7) is the case in which the spare camera 106 does not satisfy the second condition. On the other hand, the sensor assignment section 103 determines, in the first embodiment, that the case in which the number of a plurality of voxels situated in a sensing range of the spare camera 106 is less than or equal to the first threshold and the probability of occupation of each of the plurality of voxels situated in the sensing range of the spare camera 106 is less than or equal to the second threshold (Step S115 in FIG. 4) is the case in which the spare camera 106 does not satisfy the second condition. In other words, only one of the conditions is adopted. Instead, the case in which both of the conditions are satisfied may be determined to be the case in which the spare camera 106 does not satisfy the second condition.

### VIII. FOURTH MODIFICATION

When the secondary sensor 205 does not satisfy a first condition and the spare sensor 206 does not satisfy a second condition, it is sufficient if the sensor assignment section 203 determines that the secondary sensor 205 and the spare sensor 206 are not to be used for location estimation. This is a modification of the second embodiment and the fourth embodiment.

When the success rate of location estimation performed on the basis of spare distance-data is less than the fourth threshold, and/or when the number of a plurality of voxels situated in a sensing range of the spare sensor 206 is less than or equal to the first threshold and the probability of occupation of each of the plurality of voxels situated in the sensing range of the spare sensor 206 is less than or equal to the second threshold, it is sufficient if the sensor assignment section 203 determines that the spare sensor 206 does not satisfy the second condition.

In other words, the sensor assignment section 203 determines, in the fourth embodiment, that the case in which the success rate of location estimation performed on the basis of spare distance-data is less than the fourth threshold (Step S415 in FIG. 8) is the case in which the spare sensor 206 satisfies the second condition. On the other hand, the sensor assignment section 203 determines, in the second embodiment, that the case in which the number of a plurality of voxels situated in a sensing range of the spare sensor 206 is less than or equal to the first threshold and the probability of occupation of each of the plurality of voxels situated in the sensing range of the spare sensor 206 is less than or equal to the second threshold (Step S215 in FIG. 6) is the case in which the spare sensor 206 satisfies the second condition. In other words, only one of the conditions is adopted. Instead, the case in which both of the conditions are satisfied may be determined to be the case in which the spare sensor 206 does not satisfy the second condition.

### IX. FIFTH MODIFICATION

In the case in which the secondary camera 105 and the spare camera 106 are not to be used for location estimation, it is sufficient if the location integration section 114 integrates a primary sensor estimated location and a ranging sensor estimated location without integrating a secondary sensor estimated location when a degree of reliability of the ranging sensor 101 is greater than or equal to the fifth threshold, and/or when the number of a plurality of voxels situated in a sensing range of the ranging sensor 101 is greater than the first threshold and the probability of occupation of each of the plurality of voxels situated in the sensing range of the ranging sensor 101 is greater than the second threshold. This is a modification of the first embodiment and the third embodiment.

In other words, the location integration section 114 integrates, in the third embodiment, estimated locations on the basis of distance data acquired by the ranging sensor 101 when a degree of reliability of the ranging sensor 101 is greater than or equal to the fifth threshold (Step S320 in FIG. 7). On the other hand, the location integration section 114 integrates, in the first embodiment, estimated locations on the basis of distance data acquired by the ranging sensor 101 when the number V_sum of a plurality of voxels situated in a sensing range of the ranging sensor 101 is greater than the first threshold V_th and the probability P_occ of occupation of each of the plurality of voxels situated in the sensing range of the ranging sensor 101 is greater than the second threshold P_th (Step S120 in FIG. 4). In other words, only one of the conditions is adopted. Instead, estimated locations may be integrated on the basis of distance data acquired by the ranging sensor 101 when both of the conditions are satisfied.

### X. CONCLUSION

According to the embodiments of the present disclosure, the mobile object 10 includes at least four sensors (cameras or ranging sensors). The location estimation system only selects two of the at least four sensors to estimate a location and a pose of the mobile object 10. The location estimation system repeats a loop process of selecting two optimal sensors to change a pair of sensors to be used. Consequently, the location estimation system can estimate, at all times, a location and a pose of the mobile object 10 using an optimal pair of sensors, and can estimate the location and the pose of the mobile object 10 using at least four sensors to the fullest extent. Further, when the location estimation system changes a pair of sensors, one of paired sensors (a first sensor) is not changed, whereas another of the paired sensors (a second sensor) is changed. In other words, only one of paired sensors is changed at a time. Furthermore, one of paired sensors (a first sensor) that is more reliable is not changed, whereas another of the paired sensors (a second sensor) that is relatively less reliable is changed. Then, upon estimating a location, sensor data of the more reliable unchanged sensor (the first sensor) is used when the changed sensor (the second sensor) exhibits a large error. This makes it possible to perform smoothing on the location. Further, a simple change in sensor (for example, selecting two pairs of sensors at random) may result in the occurrence of discontinuity in a temporal change in location. However, in the present embodiments, a spare sensor adjacent to a primary sensor and situated on another side of the primary sensor is newly assigned as a secondary sensor when there is a change in secondary sensor. In other words, the primary sensor being relatively highly reliable is not changed, whereas the secondary sensor is changed from a sensor adjacent to the primary sensor and situated on one of sides of the primary sensor to a sensor adjacent to the primary sensor and situated on another of the sides of the primary sensor. Such a change approach makes it possible to perform smoothing on a location to the fullest extent, and thus to suppress the occurrence of discontinuity. This results in obtaining a more reliable location. Further, the embodiments of the present disclosure result in a location being less likely to be lost even if only a relatively small number of feature points are included in image data. When a failure has occurred in one sensor, the use of another sensor makes it possible to make up for the failure to obtain a location. Furthermore, the location estimation system only selects two of at least four sensors to estimate a location and a pose of the mobile object 10. This makes it possible to increase a degree of reliability of location estimation, as described above, and to reduce a calculation load imposed upon performing the location estimation. This results in being able to reduce power consumption.

The present disclosure may also include the following configurations.
(1) A location estimation system, including:
   at least four directional sensors that each acquire data used to estimate a location and a pose of a mobile object;
   a sensor assignment section that
      assigns one of the at least four sensors as a first sensor,
      assigns, as a second sensor, one of the at least four sensors that is adjacent to the first sensor and situated on one of sides of the first sensor,
      assigns, as a spare sensor, one of the at least four sensors that is adjacent to the first sensor and situated on another of the sides of the first sensor, and
      swaps the assignments of the second sensor and the spare sensor when the second sensor does not satisfy a first condition and the spare sensor satisfies a second condition;
   an environment map generator that generates an environment map on the basis of first sensor data that is data acquired by the first sensor and on the basis of second sensor data that is data acquired by the second sensor;
   a first location estimator that estimates the location and the pose in the environment map on the basis of the first sensor data to generate a first sensor estimated location;
   a second location estimator that estimates the location and the pose in the environment map on the basis of the second sensor data to generate a second sensor estimated location; and
   a location integration section that integrates the first sensor estimated location and the second sensor estimated location to estimate the location and the pose of the mobile object in the environment map.
(2) The location estimation system according to (1), in which
   the sensor assignment section swaps the assignments of the first sensor and the second sensor when the number of feature points included in the first sensor data is less than or equal to the number of feature points included in the second sensor data and/or when a success rate of location estimation performed on the basis of the first sensor data is less than or equal to a success rate of location estimation performed on the basis of the second sensor data.
(3) The location estimation system according to (1) or (2), in which
   the second location estimator newly generates a second sensor estimated location on the basis of second sensor data acquired by the newly assigned second sensor, and
   the location integration section integrates the first sensor estimated location and the newly generated second sensor estimated location to estimate the location and the pose of the mobile object.
(4) The location estimation system according to (3), in which
   when the number of feature points included in the second sensor data is less than or equal to the number of feature points included in spare sensor data that is data acquired by the spare sensor, and/or when the number of a plurality of voxels situated in a sensing range of the second sensor is less than or equal to a first threshold and the probability of occupation of each of the plurality of voxels situated in the sensing range of the second sensor is less than or equal to a second threshold, the sensor assignment section determines that the second sensor does not satisfy the first condition, the plurality of voxels being included in the environment map, the probability of occupation of each of the plurality of voxels being represented in the environment map, or
   when a success rate of location estimation performed on the basis of the second sensor data is less than or equal to a success rate of location estimation performed on the basis of the spare sensor data, and/or when the number of the plurality of voxels situated in the sensing range of the second sensor is less than or equal to the first threshold and the probability of occupation of each of the plurality of voxels situated in the sensing range of the second sensor is less than or equal to the second threshold, the sensor assignment section determines that the second sensor does not satisfy the first condition.
(5) The location estimation system according to (3) or (4), in which
   when the number of feature points included in spare sensor data that is data acquired by the spare sensor is greater than or equal to a third threshold, and/or when the number of a plurality of voxels situated in a sensing range of the spare sensor is greater than a first threshold and the probability of occupation of each of the plurality of voxels situated in the sensing range of the spare sensor is greater than a second threshold, the sensor assignment section determines that the spare sensor satisfies the second condition, the plurality of voxels being included in the environment map, the probability of occupation of each of the plurality of voxels being represented in the environment map, or
   when a success rate of location estimation performed on the basis of the spare sensor data is greater than or equal to a fourth threshold, and/or when the number of the plurality of voxels situated in the sensing range of the spare sensor is greater than the first threshold and the probability of occupation of each of the plurality of voxels situated in the sensing range of the spare sensor is greater than the second threshold, the sensor assignment section determines that the spare sensor satisfies the second condition.
(6) The location estimation system according to any one of (3) to (5), in which
   when the second sensor does not satisfy the first condition and the spare sensor does not satisfy the second condition, the sensor assignment section determines that the second sensor and the spare sensor are not to be used for location estimation.
(7) The location estimation system according to (6), in which
   when the number of feature points included in spare sensor data that is data acquired by the spare sensor is less than a third threshold, and/or when the number of a plurality of voxels situated in a sensing range of the spare sensor is less than or equal to a first threshold and the probability of occupation of each of the plurality of voxels situated in the sensing range of the spare sensor is less than or equal to a second threshold, the sensor assignment section determines that the spare sensor does not satisfy the second condition, the plurality of voxels being included in the environment map, the probability of occupation of each of the plurality of voxels being represented in the environment map, or
   when a success rate of location estimation performed on the basis of the spare sensor data is less than a fourth threshold, and/or when the number of the plurality of voxels situated in the sensing range of the spare sensor is less than or equal to the first threshold and the probability of occupation of each of the plurality of voxels situated in the sensing range of the spare sensor is less than or equal to the second threshold, the sensor assignment section determines that the spare sensor does not satisfy the second condition.
(8) The location estimation system according to (6) or (7), further including:
   a directional ranging-type sensor that acquires data used to estimate the location and the pose of the mobile object; and
   a third location estimator that estimates the location and the pose in the environment map on the basis of sensor data acquired by the ranging-type sensor to generate a second sensor estimated location, in which
   in a case in which the sensor assignment section determines that the second sensor and the spare sensor are not to be used for location estimation,
      the location integration section integrates the first sensor estimated location and the second sensor estimated location to estimate the location and the pose of the mobile object when a degree of reliability of the ranging-type sensor is greater than or equal to a fifth threshold, and/or when the number of a plurality of voxels situated in a sensing range of the ranging-type sensor is greater than a first threshold and the probability of occupation of each of the plurality of voxels situated in the sensing range of the ranging-type sensor is greater than a second threshold, the plurality of voxels being included in the environment map, the probability of occupation of each of the plurality of voxels being represented in the environment map.
(9) The location estimation system according to any one of (1) to (8), further including:
   an internal sensor that acquires internal data used to estimate the location and the pose of the mobile object; and
   a fourth location estimator that estimates the location and the pose in the environment map on the basis of the internal data acquired by the internal sensor to generate a displacement measured by odometry, in which
   the location integration section further integrates the displacement measured by odometry with the first sensor estimated location and the second sensor estimated location to estimate the location and the pose of the mobile object.
(10) The location estimation system according to any one of (1) to (9), in which
   the at least four sensors are image-capturing sensors or ranging sensors that each measure a distance on the basis of a signal received from an environment.
(11) The location estimation system according to any one of (1) to (10), in which
   the mobile object is a flying object.
(12) A mobile object, including:
   at least four directional sensors that each acquire data used to estimate a location and a pose of the mobile object; and
   a control circuit that operates as
      a sensor assignment section that
         assigns one of the at least four sensors as a first sensor,
         assigns, as a second sensor, one of the at least four sensors that is adjacent to the first sensor and situated on one of sides of the first sensor,
         assigns, as a spare sensor, one of the at least four sensors that is adjacent to the first sensor and situated on another of the sides of the first sensor, and
         swaps the assignments of the second sensor and the spare sensor when the second sensor does not satisfy a first condition and the spare sensor satisfies a second condition,
      an environment map generator that generates an environment map on the basis of first sensor data that is data acquired by the first sensor and on the basis of second sensor data that is data acquired by the second sensor,
      a first location estimator that estimates the location and the pose in the environment map on the basis of the first sensor data to generate a first sensor estimated location,
      a second location estimator that estimates the location and the pose in the environment map on the basis of the second sensor data to generate a second sensor estimated location, and
      a location integration section that integrates the first sensor estimated location and the second sensor estimated location to estimate the location and the pose of the mobile object in the environment map.
(13) A location estimation method that is a method for estimating a location and a pose of a mobile object that includes at least four directional sensors, the location estimation method including:
   assigning one of the at least four sensors as a first sensor;
   assigning, as a second sensor, one of the at least four sensors that is adjacent to the first sensor and situated on one of sides of the first sensor;
   assigning, as a spare sensor, one of the at least four sensors that is adjacent to the first sensor and situated on another of the sides of the first sensor;
   swapping the assignments of the second sensor and the spare sensor when the second sensor does not satisfy a first condition and the spare sensor satisfies a second condition;
   generating an environment map on the basis of first sensor data that is data acquired by the first sensor and on the basis of second sensor data that is data acquired by the second sensor;
   estimating the location and the pose in the environment map on the basis of the first sensor data to generate a first sensor estimated location;
   estimating the location and the pose in the environment map on the basis of the second sensor data to generate a second sensor estimated location; and
   integrating the first sensor estimated location and the second sensor estimated location to estimate the location and the pose of the mobile object in the environment map.
(14) A non-transitory computer-readable recording medium that records therein a location estimation program that causes a control circuit to operate as
   a sensor assignment section that
      assigns, as a first sensor, one of at least four directional sensors that each acquire data used to estimate a location and a pose of a mobile object,
      assigns, as a second sensor, one of the at least four sensors that is adjacent to the first sensor and situated on one of sides of the first sensor,
      assigns, as a spare sensor, one of the at least four sensors that is adjacent to the first sensor and situated on another of the sides of the first sensor, and
      swaps the assignments of the second sensor and the spare sensor when the second sensor does not satisfy a first condition and the spare sensor satisfies a second condition,
   an environment map generator that generates an environment map on the basis of first sensor data that is data acquired by the first sensor and on the basis of second sensor data that is data acquired by the second sensor,
   a first location estimator that estimates the location and the pose in the environment map on the basis of the first sensor data to generate a first sensor estimated location,
   a second location estimator that estimates the location and the pose in the environment map on the basis of the second sensor data to generate a second sensor estimated location, and
   a location integration section that integrates the first sensor estimated location and the second sensor estimated location to estimate the location and the pose of the mobile object in the environment map,
   the control circuit being capable of communicating with the at least four sensors.
(15) A location estimation program that causes a control circuit to operate as
   a sensor assignment section that
      assigns, as a first sensor, one of at least four directional sensors that each acquire data used to estimate a location and a pose of a mobile object,
      assigns, as a second sensor, one of the at least four sensors that is adjacent to the first sensor and situated on one of sides of the first sensor,
      assigns, as a spare sensor, one of the at least four sensors that is adjacent to the first sensor and situated on another of the sides of the first sensor, and
      swaps the assignments of the second sensor and the spare sensor when the second sensor does not satisfy a first condition and the spare sensor satisfies a second condition,
   an environment map generator that generates an environment map on the basis of first sensor data that is data acquired by the first sensor and on the basis of second sensor data that is data acquired by the second sensor,
   a first location estimator that estimates the location and the pose in the environment map on the basis of the first sensor data to generate a first sensor estimated location,
   a second location estimator that estimates the location and the pose in the environment map on the basis of the second sensor data to generate a second sensor estimated location, and
   a location integration section that integrates the first sensor estimated location and the second sensor estimated location to estimate the location and the pose of the mobile object in the environment map,
   the control circuit being capable of communicating with the at least four sensors.

The embodiments and the modifications of the present technology have been described above. Of course the present technology is not limited to the embodiments described above, and various modifications may be made thereto without departing from the scope of the present technology.

### REFERENCE SIGNS LIST

10 mobile object
101 ranging sensor
102 internal sensor
103 sensor assignment section
104 primary camera
105 secondary camera
106 spare camera
107 environment map generator
108 environment map database
109 feature point extracting section
110 first location estimator
111 second location estimator
112 third location estimator
113 fourth location estimator
114 location integration section
115 environment map
202 internal sensor
203 sensor assignment section
204 primary sensor
205 secondary sensor
206 spare sensor
207 environment map generator
208 environment map database
210 first location estimator
211 second location estimator
213 fourth location estimator
214 location integration section
215 environment map
216 learning section
217 superiority extraction section
218 location-restoration computation section

1. A location estimation system, comprising:
at least four directional sensors that each acquire data used to estimate a location and a pose of a mobile object;
a sensor assignment section that
assigns one of the at least four sensors as a first sensor,
assigns, as a second sensor, one of the at least four sensors that is adjacent to the first sensor and situated on one of sides of the first sensor,
assigns, as a spare sensor, one of the at least four sensors that is adjacent to the first sensor and situated on another of the sides of the first sensor, and
swaps the assignments of the second sensor and the spare sensor when the second sensor does not satisfy a first condition and the spare sensor satisfies a second condition;
an environment map generator that generates an environment map on a basis of first sensor data that is data acquired by the first sensor and on a basis of second sensor data that is data acquired by the second sensor;
a first location estimator that estimates the location and the pose in the environment map on the basis of the first sensor data to generate a first sensor estimated location;
a second location estimator that estimates the location and the pose in the environment map on the basis of the second sensor data to generate a second sensor estimated location; and
a location integration section that integrates the first sensor estimated location and the second sensor estimated location to estimate the location and the pose of the mobile object in the environment map.

2. The location estimation system according to claim 1, wherein
the sensor assignment section swaps the assignments of the first sensor and the second sensor when the number of feature points included in the first sensor data is less than or equal to the number of feature points included in the second sensor data and/or when a success rate of location estimation performed on the basis of the first sensor data is less than or equal to a success rate of location estimation performed on the basis of the second sensor data.

3. The location estimation system according to claim 1, wherein
the second location estimator newly generates a second sensor estimated location on a basis of second sensor data acquired by the newly assigned second sensor, and
the location integration section integrates the first sensor estimated location and the newly generated second sensor estimated location to estimate the location and the pose of the mobile object.

4. The location estimation system according to claim 3, wherein
when the number of feature points included in the second sensor data is less than or equal to the number of feature points included in spare sensor data that is data acquired by the spare sensor, and/or when the number of a plurality of voxels situated in a sensing range of the second sensor is less than or equal to a first threshold and the probability of occupation of each of the plurality of voxels situated in the sensing range of the second sensor is less than or equal to a second threshold, the sensor assignment section determines that the second sensor does not satisfy the first condition, the plurality of voxels being included in the environment map, the probability of occupation of each of the plurality of voxels being represented in the environment map, or
when a success rate of location estimation performed on the basis of the second sensor data is less than or equal to a success rate of location estimation performed on a basis of the spare sensor data, and/or when the number of the plurality of voxels situated in the sensing range of the second sensor is less than or equal to the first threshold and the probability of occupation of each of the plurality of voxels situated in the sensing range of the second sensor is less than or equal to the second threshold, the sensor assignment section determines that the second sensor does not satisfy the first condition.

5. The location estimation system according to claim 3, wherein
when the number of feature points included in spare sensor data that is data acquired by the spare sensor is greater than or equal to a third threshold, and/or when the number of a plurality of voxels situated in a sensing range of the spare sensor is greater than a first threshold and the probability of occupation of each of the plurality of voxels situated in the sensing range of the spare sensor is greater than a second threshold, the sensor assignment section determines that the spare sensor satisfies the second condition, the plurality of voxels being included in the environment map, the probability of occupation of each of the plurality of voxels being represented in the environment map, or
when a success rate of location estimation performed on a basis of the spare sensor data is greater than or equal to a fourth threshold, and/or when the number of the plurality of voxels situated in the sensing range of the spare sensor is greater than the first threshold and the probability of occupation of each of the plurality of voxels situated in the sensing range of the spare sensor is greater than the second threshold, the sensor assignment section determines that the spare sensor satisfies the second condition.

6. The location estimation system according to claim 3, wherein
when the second sensor does not satisfy the first condition and the spare sensor does not satisfy the second condition, the sensor assignment section determines that the second sensor and the spare sensor are not to be used for location estimation.

7. The location estimation system according to claim 6, wherein
when the number of feature points included in spare sensor data that is data acquired by the spare sensor is less than a third threshold, and/or when the number of a plurality of voxels situated in a sensing range of the spare sensor is less than or equal to a first threshold and the probability of occupation of each of the plurality of voxels situated in the sensing range of the spare sensor is less than or equal to a second threshold, the sensor assignment section determines that the spare sensor does not satisfy the second condition, the plurality of voxels being included in the environment map, the probability of occupation of each of the plurality of voxels being represented in the environment map, or
when a success rate of location estimation performed on a basis of the spare sensor data is less than a fourth threshold, and/or when the number of the plurality of voxels situated in the sensing range of the spare sensor is less than or equal to the first threshold and the probability of occupation of each of the plurality of voxels situated in the sensing range of the spare sensor is less than or equal to the second threshold, the sensor assignment section determines that the spare sensor does not satisfy the second condition.

8. The location estimation system according to claim 6, further comprising:
a directional ranging-type sensor that acquires data used to estimate the location and the pose of the mobile object; and
a third location estimator that estimates the location and the pose in the environment map on a basis of sensor data acquired by the ranging-type sensor to generate a second sensor estimated location, wherein
in a case in which the sensor assignment section determines that the second sensor and the spare sensor are not to be used for location estimation,
the location integration section integrates the first sensor estimated location and the second sensor estimated location to estimate the location and the pose of the mobile object when a degree of reliability of the ranging-type sensor is greater than or equal to a fifth threshold, and/or when the number of a plurality of voxels situated in a sensing range of the ranging-type sensor is greater than a first threshold and the probability of occupation of each of the plurality of voxels situated in the sensing range of the ranging-type sensor is greater than a second threshold, the plurality of voxels being included in the environment map, the probability of occupation of each of the plurality of voxels being represented in the environment map.

9. The location estimation system according to claim 1, further comprising:
an internal sensor that acquires internal data used to estimate the location and the pose of the mobile object; and
a fourth location estimator that estimates the location and the pose in the environment map on a basis of the internal data acquired by the internal sensor to generate a displacement measured by odometry, wherein
the location integration section further integrates the displacement measured by odometry with the first sensor estimated location and the second sensor estimated location to estimate the location and the pose of the mobile object.

10. The location estimation system according to claim 1, wherein
the at least four sensors are image-capturing sensors or ranging sensors that each measure a distance on a basis of a signal received from an environment.

11. The location estimation system according to claim 1, wherein
the mobile object is a flying object.

12. A mobile object, comprising:
at least four directional sensors that each acquire data used to estimate a location and a pose of the mobile object; and
a control circuit that operates as
a sensor assignment section that
assigns one of the at least four sensors as a first sensor,
assigns, as a second sensor, one of the at least four sensors that is adjacent to the first sensor and situated on one of sides of the first sensor,
assigns, as a spare sensor, one of the at least four sensors that is adjacent to the first sensor and situated on another of the sides of the first sensor, and
swaps the assignments of the second sensor and the spare sensor when the second sensor does not satisfy a first condition and the spare sensor satisfies a second condition,
an environment map generator that generates an environment map on a basis of first sensor data that is data acquired by the first sensor and on a basis of second sensor data that is data acquired by the second sensor,
a first location estimator that estimates the location and the pose in the environment map on the basis of the first sensor data to generate a first sensor estimated location,
a second location estimator that estimates the location and the pose in the environment map on the basis of the second sensor data to generate a second sensor estimated location, and
a location integration section that integrates the first sensor estimated location and the second sensor estimated location to estimate the location and the pose of the mobile object in the environment map.

13. A location estimation method that is a method for estimating a location and a pose of a mobile object that includes at least four directional sensors, the location estimation method comprising:
assigning one of the at least four sensors as a first sensor;
assigning, as a second sensor, one of the at least four sensors that is adjacent to the first sensor and situated on one of sides of the first sensor;
assigning, as a spare sensor, one of the at least four sensors that is adjacent to the first sensor and situated on another of the sides of the first sensor;
swapping the assignments of the second sensor and the spare sensor when the second sensor does not satisfy a first condition and the spare sensor satisfies a second condition;
generating an environment map on a basis of first sensor data that is data acquired by the first sensor and on a basis of second sensor data that is data acquired by the second sensor;
estimating the location and the pose in the environment map on the basis of the first sensor data to generate a first sensor estimated location;
estimating the location and the pose in the environment map on the basis of the second sensor data to generate a second sensor estimated location; and
integrating the first sensor estimated location and the second sensor estimated location to estimate the location and the pose of the mobile object in the environment map.

14. A non-transitory computer-readable recording medium that records therein a location estimation program that causes a control circuit to operate as
a sensor assignment section that
assigns, as a first sensor, one of at least four directional sensors that each acquire data used to estimate a location and a pose of a mobile object,
assigns, as a second sensor, one of the at least four sensors that is adjacent to the first sensor and situated on one of sides of the first sensor,
assigns, as a spare sensor, one of the at least four sensors that is adjacent to the first sensor and situated on another of the sides of the first sensor, and
swaps the assignments of the second sensor and the spare sensor when the second sensor does not satisfy a first condition and the spare sensor satisfies a second condition,
an environment map generator that generates an environment map on a basis of first sensor data that is data acquired by the first sensor and on a basis of second sensor data that is data acquired by the second sensor,
a first location estimator that estimates the location and the pose in the environment map on the basis of the first sensor data to generate a first sensor estimated location,
a second location estimator that estimates the location and the pose in the environment map on the basis of the second sensor data to generate a second sensor estimated location, and
a location integration section that integrates the first sensor estimated location and the second sensor estimated location to estimate the location and the pose of the mobile object in the environment map,
the control circuit being capable of communicating with the at least four sensors.
